(19) United States
(12) Patent Application Publication
(10) Pub. No.: US 2025/0065301 A1
(43) Pub. Date: Feb. 27, 2025

(54) Mass Production of Multivariate Metal-Organic Frameworks for Water Harvesting

(71) Applicant: The Regents of the University of California, Oakland, CA (US)

(72) Inventors: Omar M. Yaghi, Berkeley, CA (US); Nikita Hanikel, Berkeley, CA (US); Zhiling Zheng, Berkeley, CA (US)

(21) Appl. No.: 18/946,467

(22) Filed: Nov. 13, 2024

Related U.S. Application Data
(63) Continuation of application No. PCT/US2023/065830, filed on Apr. 15, 2023.
(60) Provisional application No. 63/480,508, filed on Jan. 18, 2023.
(60) Provisional application No. 63/419,677, filed on Oct. 26, 2022.
(60) Provisional application No. 63/342,625, filed on May 16, 2022.

(51) Int. Cl. B01J 20/22; B01D 53/02; B01J 20/28; B01J 20/30; C07F 5/06

(52) U.S. Cl. CPC B01J 20/226; B01D 53/02; B01J 20/28064; B01J 20/28066; B01J 20/28071; B01J 20/2808; B01J 20/3085; C07F 5/069; B01D 2253/204; B01D 2253/306; B01D 2253/308; B01D 2253/311; B01D 2257/80

(57) ABSTRACT

Multivariate metal-organic framework (MTV-MOF) composition are synthesized in a hydrothermal reaction between a metal and deprotonated linkers mixed at different ratios in a relatively rapid, facile, scalable, and high-yield synthesis method of the MTV-MOF on a kilogram-scale.

This invention was made with government support under grant number HR0011-21-C-002 from the Department of Defense Advanced Research Projects Agency. The government has certain rights in the invention.

### INTRODUCTION

Water scarcity is one of the greatest long-term challenges facing society today¹⁻³. The extraction water from the atmosphere, a decentralized strategy for freshwater generation that is not limited by temporal and spatial variation on distribution of available water, has potential for alleviating this problem⁴⁻⁶. Recent research has shown that porous metal-organic frameworks (MOFs) are excellent candidates for harvesting atmospheric water due to their intrinsic porosity, unprecedented variety, and high tunability^{7, 8}. However, few are applicable under practical conditions. In order to be employed under practical conditions, water-harvesting MOFs need to exhibit a high water uptake, a low energetic cost of regeneration, as well as be hydrothermally stable and display fast cycling performance. Importantly, in addition to the above-mentioned factors, the optimal material should be relatively inexpensive, scalable, and synthetically tunable to allow its real-world application under various conditions⁹⁻¹².

To address the tunability of water-harvesting MOFs, recently, it was demonstrated that the multivariate (MTV) approach¹³⁻¹⁵, in which MOFs are prepared from a combination of multiple linkers within one crystalline material, can successfully introduce a continuous change in the atmospheric water-harvesting capabilities of multivariate MOFs and therefore be applied to precisely tune the position of steep pore-filling step of the isotherm^{10, 16-18}. Nevertheless, most of the research done on MTV-MOFs is limited to the laboratory scale and it remains challenging to develop a general and scalable protocol to produce MTV-MOFs on the kilogram scale. In addition, there is a lack of systematic synthesis methods that can be adapted to produce MTV-MOFs with controlled linker ratios on a large scale. Additionally, MOFs produced at scale often exhibit low product quality, such as reduced crystallinity and porosity, as well as non-uniform particle size¹⁹⁻²¹.

### SUMMARY OF THE INVENTION

In an aspect the invention provides methods and compositions for industrial (kilogram) scale production of multivariate metal-organic frameworks, especially for water harvesting.

In an aspect the invention provides a method of making a multivariate metal-organic framework (MTV-MOF) composition comprising synthesizing the MTV-MOF in a hydrothermal reaction between a metal and deprotonated linkers mixed at different ratios in a relatively rapid, facile, scalable, and high-yield synthesis method of the MTV-MOF on a kilogram-scale.

In embodiments:
the MTV-MOF is composed of metal cluster-based secondary building units (SBUs) and carboxylate linkers that are connected by ionic or covalent bonds, wherein the SBUs contain one or more species of metal ions, including Li⁺, Na⁺, K⁺, Rb⁺, Cs⁺, Be²⁺, Mg²⁺, Ca²⁺, Sr²⁺, Ba²⁺, Sc²⁺, Y³⁺, Ti⁴⁺, Zr⁴⁺, Hf⁴⁺, V⁵⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, B³⁺, B⁵⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺ and their combinations, wherein in order to be charge-balanced, the SBUs can contain anion, such as O²⁻, N³⁻ and S²⁻, and optionally, the bridging —OH and neutral solvent molecules such as dimethylformamide and water can also be a part of the SBU, and the carboxylate linkers are organic aromatic or nonaromatic rings or chains that contains two or more carboxylate groups;
the MTV-MOF comprises linkers of Table A;
the method produces the MTV-MOF at kilogram scale in a 200 L batch reactor with yields of 84-96% and space-time yields of 238-305 kg/day/m³;
the yield is higher than 90% (compared to around 30% in the conventional solvothermal and hydrothermal methods);
the reaction is facilitated by a mechanical, continuous stirring mechanism to constantly stir the reaction mixture to ensure the solution of the linkers is homogeneously dispersed, which is important to ensure a precise control on the linker composition of the resulting MTV-MOF, and not achievable by traditional methods, which can result in a formation of physical mixture of two MOFs instead of MTV-MOFs;
the method comprising use of a conductive temperature regulator surrounding the reaction vessel, such as a heating jacket or oil bath;
the method configured for slow addition. In traditional single linker MOF preparation (e.g. MOF-303 patent, U.S. Pat. No. 11,014,068) the solution of metal salts (AlCl3, Liquid A) and the linker(s) (PZDC2−, Liquid B) are directly mixed in vial and transferred to the oven, enabling use of an addition funnel (see, FIG. 2, 3) to slowly add liquid A dropwise to liquid B while stirring. This step (usually last for 2 hours) is advantageous to yield the MTV-MOF products with a homogeneous particle size and sorption performance, and is important to avoid the formation of undesirable side products.

the method configured to use of corrected stoichiometry amount of base, e.g., 3 equivalence of base (mol of NaOH to mol of linker is 3) is used to maximize the reaction yield (as shown in table, the yield increase from ˜30% to >80%).

the method configured to tune the water-harvesting properties of the synthesized MTV-MOF by varying the input linker ratio and thus producing MTV-MOFs with desired linker composition and properties;
the MTV-MOF comprises pyrazoledicarboxylate and other heterocyclic dicarboxylate linkers (2,5-furandicarboxylate, 2,5-thiophenedicarboxylate, 3,4-pyrroledicarboxylate, etc.);
the method configured to produce compositions sufficient for water harvesting from desert air, adsorption-driven heat exchangers, adsorption-driven chillers, heat pumps, for air-conditioning, and/or in indoor humidity and moisture controllers.

The invention encompasses all combinations of the particular embodiments recited herein, as if each combination had been laboriously recited.

### BRIEF DESCRIPTION OF THE DRAWINGS

FIG. 1a-c. a) Generation of multivariate MOFs from 1H-pyrazole-3,5-dicarboxylic acid (H₂PZDC) and thiophene-2,5-dicarboxylic acid (H₂TDC). Employing H₂PZDC or H₂TDC as linkers in single-linker MOFs results in MOF-303⁹ or CAU-23²¹, which exhibit ‘infinite’ secondary building units consisting of (b) cis-trans-alternating or (c) (cis)₄-(trans)₄-alternating corned-shared AlO₆ octahedra, respectively. Dependent on the input linker ratio, base concentration, synthesis method, and reaction time, multivariate MOFs isostructural to MOF-303 or CAU-23 can be generated. The spatial linker distribution in the multivariate MOF series was not determined on the molecular level and is depicted arbitrarily. Al, blue octahedron in (a); trans-corner-shared AlO₆ octahedron, blue in (b) and (c); cis-corner-shared AlO₆ octahedron, green in (b) and (c); 0, pink; C, gray; N, green; S, orange. H atoms are omitted for clarity.

FIG. 2. Synthesis of multivariate PT-HY-MOFs under reflux conditions in a flask: schematic representation of the ex-perimental setup.

FIG. 3. Synthesis of multivariate PT-MOFs under reflux conditions in a reaction vessel: schematic representation of the experimental setup.

FIG. 4. Illustration of the X-ray diffraction single-crystal structures of relevant MOFs in this work. The aluminum-based MOFs are constructed using ditopic carboxylate linkers with opening angles ranging from 118° to 180°. The rod-like secondary building units (SBUs) consist of cis-only, trans-only, cis-trans-alternating, or (cis)₄-(trans)₄-alternating corned-shared AlO₆ octahedra (variously colored in different MOFs). Graphics are produced from cif files Al³⁺ reported in the literature^{24,26,31-33}; Color code: O, red; C, gray; N, purple; S, orange. H atoms are omitted for clarity.

### DESCRIPTION OF PARTICULAR EMBODIMENTS OF THE INVENTION

Unless contraindicated or noted otherwise, in these descriptions and throughout this specification, the terms “a” and “an” mean one or more, the term “or” means and/or. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein, including citations therein, are hereby incorporated by reference in their entirety for all purposes.

For real-life applications, porous materials are required to be tunable and scalable. This invention provides novel vessel synthesis and purification methods of MTV-MOFs that can be scaled up to the kilogram scale with retention of crystallinity and porosity. The invention enables a choice of reaction solvent such as alcohols, amides, ketones and sulphoxides. We also report the water vapor isotherms of the MTV-MOFs prepared by these method.

The disclosed synthesis method of single-linker and multivariate (mixed-linker) metal-organic frameworks enables applications that rely on large-scale production of porous materials. This method can be used to produce multivariate MOFs that can take up water in arid conditions (≤40% RH) on a kilogram scale, while maintaining the ability to tune the steep isotherm step of the product at a very low relative humidity (RH). Importantly, this allows the use of the respective materials for atmospheric water extraction. The multivariate metal-organic frameworks can also be employed in devices for diverse purposes including adsorption-driven heat exchangers, heat pumps, autonomous indoor humidity control units, adsorption/desiccation units for sewage treatment, adsorption-driven refrigerating machines, air conditioners or coolers, as well as units for removing volatile organic compounds (VOCs).

Traditional vial-based solvothermal synthesis is limited by the size of reaction vial or bottle, so it is challenging to produce MOF or MTV-MOF that is greater than 10 g per batch. Furthermore, the long reaction time and the low yield increase the cost of manufacturing. Our methods enable kilo-gram scale production of MTV-MOFs, and the water sorption properties can be similar to those in small scale, which is essential because prior attempts to scale up MOF synthesis showed a decreased sorption property.

One important feature of our industrial-scale production method is a mechanical, continuous stirring mechanism to constantly stir the reaction mixture to ensure the solution of two linkers is homogeneously dispersed, which is important to ensure a precise control on the linker composition of the resulting MTV-MOF, and not achievable by traditional methods, which can result in a formation of physical mixture of two MOFs instead of MTV-MOFs. Another important feature is the use of a conductive temperature regulator surrounding the reaction vessel, such as a heating jacket or oil bath.

| | | | MTV-MOF | | | |
|---|---|---|---|---|---|---|
| | | | Production | Reaction | | |
| | Reaction Environment | Stirring | Scale | time | | Yield |
| Traditional | 20 mL vials in preheated | No stirring | ~1 g | 15 | hours | 30%~40% |
| method | oven | | | | | |
| Our method | 250 mL round bottom | Magnetic | 1 g-3 g | 3 | hours | >90% |
| (small scale) | flask in oil bath | stirring bar | | | | |
| | | (200 rpm) | | | | |
| Our method | 200 L vessel with | Spinner | 1 kg-3 kg | 3-8 | hours | >80% |
| (large scale) | heating jacket | (200 rpm) | | | | |

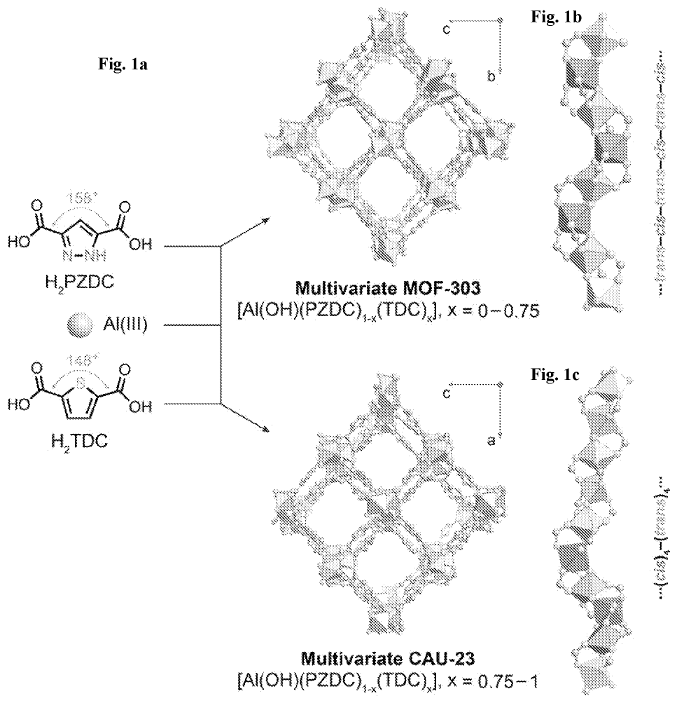

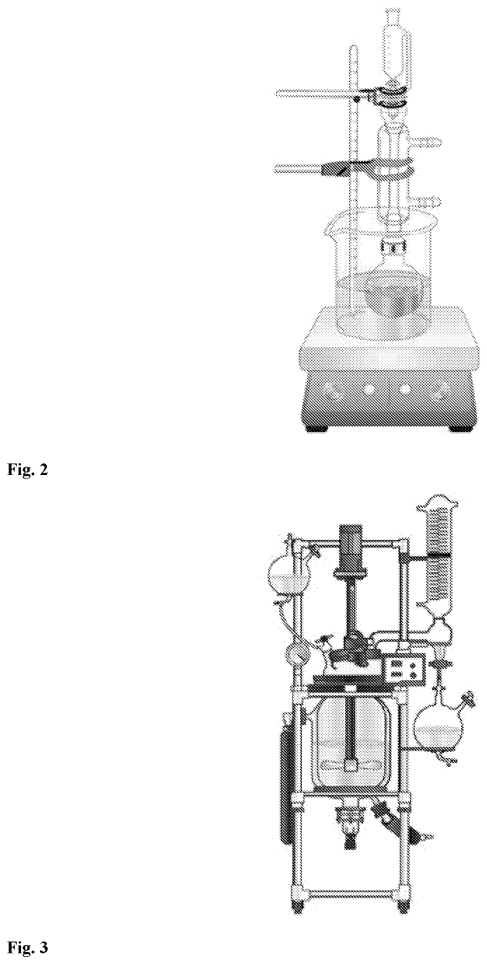

Another important feature is “slow addition”. In traditional single linker MOF preparation (e.g. MOF-303 patent, U.S. Pat. No. 11,014,068) the solution of metal salts (AlCl3, Liquid A) and the linker(s) (PZDC2−, Liquid B) are directly mixed in vial and transferred to the oven. In our new system, the set up enables us to include an addition funnel (FIG. 1f or FIG. 2k) to slowly add liquid A dropwise to liquid B while stirring. This step (usually last for 2 hours) is advantageous to yield the MTV-MOF products with a homogeneous particle size and sorption performance, and is important to avoid the formation of undesirable side products.

In another important feature, 3 equivalence of base (mol of NaOH to mol of linker is 3) is used to maximize the reaction yield (as shown in table, the yield increase from ˜30% to >80%, this is mainly due to the correct use of stoichiometry amount of base). Besides increasing the yield, this feature can be important for large scale production as the increased amount of base makes dissolution of solid linker into the water more easily and rapidly. Otherwise only 1 or 2 equivalence of NaOH will be difficult to fully dissolve kilos of linker completely and results in the incompleteness of the reaction.

To enhance the practical application of MTV-MOFs in water sorption applications, we present a synthetic approach to produce MTV-MOFs on kilogram scale and show that the crystallinity, porosity and water uptake are similar on both small-scale and large-scale synthesis of MTV-MOFs at different linker ratios. By example, we chose the MTV-MOF Al(PZDC)ₓ(TDC)₁₋ₓ(OH), where PZDC=1H-pyrazole-3,5-dicarboxylate, TDC=2,5-thiophenedicarboxylate, x=0, 0.25, 0.5, 0.75 or 1, and show that the synthesized MTV-MOFs exhibit an S-shaped water isotherm with a synthetically adjustable steep-step isotherm profile at low RH, which depends on the value of x. The three MTV-MOFs and two parent single-linker MOFs prepared by this method on kilogram scale show a high surface area between 1112 m² g⁻¹ and 1379 m² g⁻¹. In addition, the measured water uptake capacity of the scaled-up MTV-MOFs is between 0.4 and 0.45 g g⁻¹. Our synthesis and purification strategy of MTV-MOFs can be applied to other MTV-MOFs suitable for a variety of water sorption applications. The invention permits the choice of solvent from water to alcohols, amides, ketones and sulphoxides.

### Scalable and Tunable Synthesis Method of Multivariate Metal-Organic Frameworks

The synthesis of the MTV-MOFs is based on the hydrothermal reaction between the metal and the deprotonated linkers mixed at different ratios. In a particular embodiment, the reaction is carried out in a 200 L vessel reactor, as shown in FIG. 3; a more simplified set-up is shown in FIG. 2, which can be used for smaller-scale synthesis of MTV-MOFs.

The MTV-MOFs are synthesized by slowly adding the dissolved metal salt in a suitable solvent under stirring at room temperature into the reaction vessel, in which the linkers are mixed at a given ratio and dissolved in the reaction solvent. Later, the reaction mixture is heated up to a given reaction temperature and maintained at the state of refluxing for a given period of time to form the MTV-MOF. By examples, we demonstrate that this method is applicable to the synthesis of a series of MTV-MOFs with the formula Al(PZDC)ₓ(TDC)₁₋ₓ(OH) (x=0, 0.25, 0.5, 0.75 or 1) and at a scale up to 3.6 kilogram per batch. Powder X-ray diffraction (PXRD) analysis shows the high crystallinity of the synthesized MTV-MOFs. The permanent porosity of the MTV-MOFs was confirmed by nitrogen sorption measurements at 77 K. In addition to the similar water uptake working capacities, due to the difference in hydrophilicity of the two employed linkers, the MTV-MOFs show a different position of the inflection point of their water vapor adsorption curves from 0.12 to 0.26. Overall, this demonstrates that the synthesis method performs reliably in producing water-harvesting MTV-MOFs that are tunable by varying the linker input ratios.

Our methods are applicable to scaling up of multivariate metal-organic frameworks whose parent or template MOFs include, but are not limited to, MOF-5, MOF-177, IRMOF-1, IRMOF-8, Al-Fum, MIL-53, MOF-303, CAU-23, MOF-801, UiO-66, HKUST-1, and NOTT-400. Specifically, the MTV-MOFs synthesized by this method are composed of metal cluster-based secondary building units (SBUs) and carboxylate linkers that are connected by ionic or covalent bonds. The SBUs can contain one or more species of metal ions, including Li⁺, Na⁺, K⁺, Rb⁺, Cs⁺, Be²⁺, Mg²⁺, Ca²⁺, S⁺, Sc²⁺, Y³⁺, Ti⁴⁺, Zr⁴⁺, Hf⁴⁺, V⁵⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, B³⁺, B⁵⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺ and their combinations. In order to be charge-balanced, the SBUs can contain anion, such as O²⁻, N³⁻ and S²⁻. In addition, the bridging —OH and neutral solvent molecules such as dimethylformamide and water can also be a part of the SBU. For the carboxylate linkers, they are usually organic aromatic or nonaromatic rings or chains that contains two or more carboxylate groups.

TABLE A
General schematic for linkers that can be used for the scale up of MTV-MOFs.

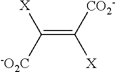

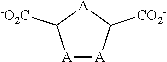

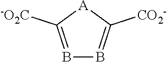

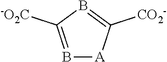

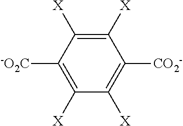

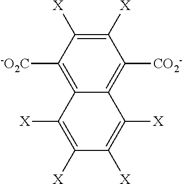

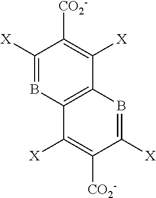

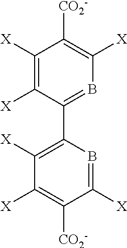

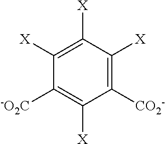

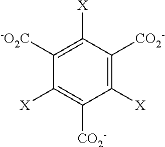

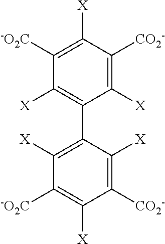

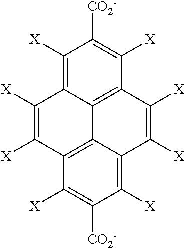

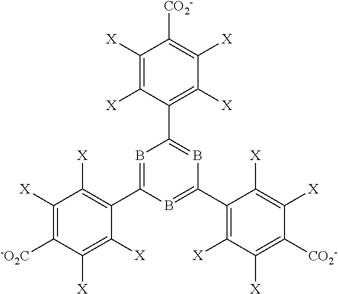

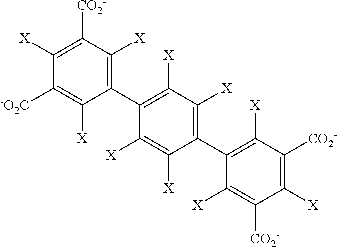

The substitution functional groups are represented as X, which can be hydrogen, alkane, alkene, alkyne, phenyl, alcohol, ether, aldehyde, ketone, epoxide, carboxylic acid, ester acyl halide, halide, amide, acid anhydride, amine, amide, nitrile, imine, azo compounds, azide, thiol, thioether and disulfide; the atoms on heterocycles are represented as A or B, which can be oxygen, nitrogen and sulfur atoms with or without hydrogen atoms, depending on the chemical bonding.

As shown in Table A, the substituting X group can be hydrogen, alkane, alkene, alkyne, phenyl, alcohol, ether, aldehyde, ketone, epoxide, carboxylic acid, ester acyl halide, halide, amide, acid anhydride, amine, amide, nitrile, imine, azo compounds, azide, thiol, thioether, disulfide and the atom A can be carbon (—CH₂—), oxygen (—O—), nitrogen (—NH—), sulfur (—S—) and the atom B can be carbon (—CH═) and nitrogen (—N═). The solvent used for the synthesis method can be water, acetic acid, acetone, acetonitrile, benzene, butanol, carbon tetrachloride, chlorobenzene, chloroform, diethyl ether, 1,2-dimethoxyethane, dimethylformamide, dimethyl sulfoxide, diethyl formamide, ethanol, ethyl acetate, hexane, methanol, methylene chloride, nitromethane, propanol, pyridine, tetrahydrofuran, toluene, triethyl amine, xylene, and their mixtures. The base used to fully deprotonate the linker can be, but is not limited to, ammonium hydroxide, lithium hydroxide, sodium hydroxide, barium hydroxide, iron hydroxide, nickel hydroxide, zirconium hydroxide, cesium hydroxide, zinc hydroxide, methylamine, imidazole, and benzimidazole and the mixture of two or more of the above compounds.

The disclosed synthesis and purification procedures are scalable and applicable to the production of a variety of metal-organic framework materials, including those suitable for atmospheric water harvesting.

### Examples: Preparation

Al(PZDC)(OH): In a 200 L glass reaction vessel, H₂PZDC (3.48 kg, 20 mol) and NaOH (2.4 kg, 60 mol) were dissolved in 38 L deionized water. The resulting solution was stirred for 60 minutes until all the solids completely dissolved and the solution cooled down to room temperature. Afterwards, AlCl₃·6H₂O (4.82 kg, 20 mol) was dissolved in 12 L deionized water and transferred to the 15 L glass material feeding funnel. The aluminum chloride solution was added at a rate of 6 L per hour to the reactor vessel with the spinner rotating at 100 rpm. The total addition time lasted for 2 hours, and a white precipitate formed during the addition. Next, the temperature of the heating jacket was set to 120° C., and it took 3 hours for the reaction mixture to slowly heat up to 100° C. After refluxing for 6 hours, the heating was terminated, and the mixture was cooled down to 60° C. The resulting white powder was collected in a 20 L filtration funnel and washed with 15 L aqueous 70% EtOH (v/v) solution. For purification, the white powder was subsequently redispersed by stirring in 30 L anhydrous EtOH at room temperature, followed by filtration and drying under air overnight. The obtained white solid was placed in an 120° C. oven for 48 hours to yield pure and desolvated product (Yield: 3.59 kg, 91% based on the linker).

Al(PZDC)_{0.75}(TDC)_{0.25}(OH): In a 200 L glass reaction vessel, H₂PZDC (2.61 kg, 15 mol) and H₂TDC (0.87 kg, 5 mol) and NaOH (2.4 kg, 60 mol) were dissolved in 38 L deionized water. The resulting solution was stirred for 60 minutes until all the solids completely dissolved and the solution cooled down to room temperature. Afterwards, AlCl₃·6H₂O (4.82 kg, 20 mol) was dissolved in 12 L deionized water and transferred to the 15 L glass material feeding funnel. The aluminum chloride solution was added at a rate of 6 L per hour to the reactor vessel with the spinner rotating at 100 rpm. The total addition time lasted for 2 hours, and a white precipitate formed during the addition. Next, the temperature of the heating jacket was set to 120° C., and it took 3 hours for the reaction mixture to slowly heat up to 100° C. After refluxing for 6 hours, the heating was terminated, and the mixture was cooled down to 60° C. The resulting white powder was collected in a 20 L filtration funnel and washed with 15 L aqueous 70% EtOH (v/v) solution. For purification, the white powder was subsequently redispersed by stirring in 30 L anhydrous EtOH at room temperature, followed by filtration and drying under air overnight. The obtained white solid was placed in an 120° C. oven for 48 hours to yield pure and desolvated product (Yield: 3.54 kg, 88% based on the linker).

Al(PZDC)_{0.5}(TDC)_{0.5}(OH): In a 200 L glass reaction vessel, H₂PZDC (1.74 kg, 10 mol) and H₂TDC (1.72 kg, 10 mol) and NaOH (2.4 kg, 60 mol) were dissolved in 38 L deionized water. The resulting solution was stirred for 60 minutes until all the solids completely dissolved and the solution cooled down to room temperature. Afterwards, AlCl₃·6H₂O (4.82 kg, 20 mol) was dissolved in 12 L deionized water and transferred to the 15 L glass material feeding funnel. The aluminum chloride solution was added at a rate of 6 L per hour to the reactor vessel with the spinner rotating at 100 rpm. The total addition time lasted for 2 hours, and a white precipitate formed during the addition. Next, the temperature of the heating jacket was set to 120° C., and it took 3 hours for the reaction mixture to slowly heat up to 100° C. After refluxing for 6 hours, the heating was terminated, and the mixture was cooled down to 60° C. The resulting white powder was collected in a 20 L filtration funnel and washed with 15 L aqueous 70% EtOH (v/v) solution. For purification, the white powder was subsequently redispersed by stirring in 30 L anhydrous EtOH at room temperature, followed by filtration and drying under air overnight. The obtained white solid was placed in an 120° C. oven for 48 hours to yield pure and desolvated product (Yield: 3.50 kg, 85% based on the linker).

Al(PZDC)_{0.25}(TDC)_{0.75}(OH): In a 200 L glass reaction vessel, H₂PZDC (0.87 kg, 5 mol) and H₂TDC (2.58 kg, 10 mol) and NaOH (2.4 kg, 60 mol) were dissolved in 38 L deionized water. The resulting solution was stirred for 60 minutes until all the solids completely dissolved and the solution cooled down to room temperature. Afterwards, AlCl₃·6H₂O (4.82 kg, 20 mol) was dissolved in 12 L deionized water and transferred to the 15 L glass material feeding funnel. The aluminum chloride solution was added at a rate of 6 L per hour to the reactor vessel with the spinner rotating at 100 rpm. The total addition time lasted for 2 hours, and a white precipitate formed during the addition. Next, the temperature of the heating jacket was set to 120° C., and it took 3 hours for the reaction mixture to slowly heat up to 100° C. After refluxing for 6 hours, the heating was terminated, and the mixture was cooled down to 60° C. The resulting white powder was collected in a 20 L filtration funnel and washed with 15 L aqueous 70% EtOH (v/v) solution. For purification, the white powder was subsequently redispersed by stirring in 30 L anhydrous EtOH at room temperature, followed by filtration and drying under air overnight. The obtained white solid was placed in an 120° C. oven for 48 hours to yield pure and desolvated product (Yield: 3.61 kg, 86% based on the linker).

Al(TDC)(OH): In a 200 L glass reaction vessel, H₂TDC (3.44 kg, 10 mol) and NaOH (2.4 kg, 60 mol) were dissolved in 38 L deionized water. The resulting solution was stirred for 60 minutes until all the solids completely dissolved and the solution cooled down to room temperature. Afterwards, AlCl₃·6H₂O (4.82 kg, 20 mol) was dissolved in 12 L deionized water and transferred to the 15 L glass material feeding funnel. The aluminum chloride solution was added at a rate of 6 L per hour to the reactor vessel with the spinner rotating at 100 rpm. The total addition time lasted for 2 hours, and a white precipitate formed during the addition. Next, the temperature of the heating jacket was set to 120° C., and it took 3 hours for the reaction mixture to slowly heat up to 100° C. After refluxing for 6 hours, the heating was terminated, and the mixture was cooled down to 60° C. The resulting white powder was collected in a 20 L filtration funnel and washed with 15 L aqueous 70% EtOH (v/v) solution. For purification, the white powder was subsequently redispersed by stirring in 30 L anhydrous EtOH at room temperature, followed by filtration and drying under air overnight. The obtained white solid was placed in an 120° C. oven for 48 hours to yield pure and desolvated product (Yield: 3.61 kg, 84% based on the linker).

### REFERENCES

1. Liu, C.-H.; Nguyen, H. L.; Yaghi, O. M., Harvesting Water from Desert Air. AsiaChem 2020, 1, 18-25.
2. Mekonnen, M. M.; Hoekstra, A. Y., Four billion people facing severe water scarcity. Sci. Adv. 2016, 2 (2), e1500323.
3. Xu, W.; Yaghi, O. M., Metal-organic frameworks for water harvesting from air, anywhere, anytime. ACS Cent. Sci. 2020, 6 (8), 1348-1354.
4. Hanikel, N.; Prévot, M. S.; Yaghi, O. M., MOF water harvesters. Nat. Nanotechnol. 2020, 15 (5), 348-355.
5. Oelkers, E. H.; Hering, J. G.; Zhu, C., Water: is there a global crisis? Elements 2011, 7 (3), 157-162.
6. Shannon, M. A.; Bohn, P. W.; Elimelech, M.; Georgiadis, J. G.; Marinas, B. J.; Mayes, A. M., Science and technology for water purification in the coming decades. Nanosci. Technol. 2010, 337-346.
7. Burtch, N. C.; Jasuja, H.; Walton, K. S., Water stability and adsorption in metal-organic frameworks. Chem. Rev. 2014, 114 (20), 10575-10612.
8. Stock, N.; Biswas, S., Synthesis of metal-organic frameworks (MOFs): routes to various MOF topologies, morphologies, and composites. Chem. Rev. 2012, 112 (2), 933-969.
9. Bagi, S.; Wright, A. M.; Oppenheim, J.; Dinca, M.; Romin-Leshkov, Y., Accelerated Synthesis of a Ni2Cl2 (BTDD) Metal-Organic Framework in a Continuous Flow Reactor for Atmospheric Water Capture. ACS Sustain. Chem. Eng. 2021, 9 (11), 3996-4003.
10. SchlMsener, C.; Xhinovci, M.; Ernst, S.-J.; Schmitz, A.; Tannert, N.; Janiak, C., Solid-solution mixed-linker synthesis of isoreticular Al-based MOFs for an easy hydrophilicity tuning in water-sorption heat transformations. Chem. Mater. 2019, 31 (11), 4051-4062.
11. Wright, A. M.; Rieth, A. J.; Yang, S.; Wang, E. N.; Dinca, M., Precise control of pore hydrophilicity enabled by post-synthetic cation exchange in metal-organic frameworks. Chem. Sci. 2018, 9 (15), 3856-3859.
12. Yang, P.; Clark, D. S.; Yaghi, O. M., Envisioning the “Air Economy”—Powered by Reticular Chemistry and Sunlight for Clean Air, Clean Energy, and Clean Water. Mol. Front. J. 2021, 1-8.
13. Deng, H.; Doonan, C. J.; Furukawa, H.; Ferreira, R. B.; Towne, J.; Knobler, C. B.; Wang, B.; Yaghi, O. M., Multiple functional groups of varying ratios in metal-organic frameworks. Science 2010, 327 (5967), 846-850.
14. Tu, B.; Pang, Q.; Wu, D.; Song, Y.; Weng, L.; Li, Q., Ordered vacancies and their chemistry in metal-organic frameworks. J. Am. Chem. Soc. 2014, 136 (41), 14465-14471.
15. Xu, W.; Tu, B.; Liu, Q.; Shu, Y.; Liang, C.-C.; Diercks, C. S.; Yaghi, O. M.; Zhang, Y.-B.; Deng, H.; Li, Q., Anisotropic reticular chemistry. Nature Reviews Materials 2020, 5 (10), 764-779.
16. Stassin, T.; Waitschat, S.; Heidenreich, N.; Reinsch, H.; Pluschkell, F.; Kravchenko, D.; Marreiros, J.; Stassen, I.; van Dinter, J.; Verbeke, R., Aqueous Flow Reactor and Vapour-Assisted Synthesis of Aluminium Dicarboxylate Metal-Organic Frameworks with Tuneable Water Sorption Properties. Chem. Eur. J. 2020, 26 (47), 10841-10848.
17. Hanikel, N.; Pei, X.; Chheda, S.; Lyu, H.; Jeong, W.; Sauer, J.; Gagliardi, L.; Yaghi, O. M., Evolution of water structures in metal-organic frameworks for improved atmospheric water harvesting. Science 2021, 374 (6566), 454-459.
18. Schlusener, C.; Jordan, D. N.; Xhinovci, M.; Ntep, T. J. M. M.; Schmitz, A.; Giesen, B.; Janiak, C., Probing the limits of linker substitution in aluminum MOFs through water vapor sorption studies: mixed-MOFs instead of mixed-linker CAU-23 and MIL-160 materials. Dalton Trans. 2020, 49 (22), 7373-7383.
19. McKinstry, C.; Cathcart, R. J.; Cussen, E. J.; Fletcher, A. J.; Patwardhan, S. V.; Sefcik, J., Scalable continuous solvothermal synthesis of metal organic framework (MOF-5) crystals. Chem. Eng. J. 2016, 285, 718-725.
20. Thomas-Hillman, I.; Laybourn, A.; Dodds, C.; Kingman, S. W., Realising the environmental benefits of metal-organic frameworks: recent advances in microwave synthesis. J. Mater. Chem. A 2018, 6 (25), 11564-11581.
21. Van Vleet, M. J.; Weng, T.; Li, X.; Schmidt, J., In situ, time-resolved, and mechanistic studies of metal-organic framework nucleation and growth. Chem. Rev. 2018, 118 (7), 3681-3721.

### Example: Broadly Tunable Atmospheric Water Harvesting in Multivariate Metal-Organic Frameworks

Water is a valuable resource of unequal global distribution and increasing demand.¹ Its scarcity in many regions of the world has detrimentally affected the quality of life of many people.^{2,3} The design of materials capable of harvesting water from air has been shown to be a potential solution for generating water, especially in arid climates.^{4,5} Recently, metal-organic frameworks (MOFs) were successfully deployed for harvesting moisture from air.⁵⁻¹¹ To further advance this emerging field of research, it is imperative to establish strategies for generation of on-demand water-harvesting systems, which can be easily tailored to a variety of environmental conditions for efficient atmospheric water harvesting anytime of the year and anywhere in the world.¹²

In this report, we highlight how the multivariate strategy of making MOFs¹³⁻¹⁵ provides a handle for controlling the hydrophilic nature of the pores and consequently the regeneration temperature and heat, as well as the humidity cut-off at which the MOF can operate. MOF-303 {[Al(OH)(PZDC)], where PZDC²⁻ is 1H-pyrazole-3,5-dicarboxylate} is the basis of our study for its demonstrated success in water-harvesting desert trials.¹⁰ Given that the N(H) groups of the PZDC²⁻ linker are the primary adsorptive sites for water molecules and the critical role the strength of this interaction plays in the building up of the water structure within the pores,⁶ we sought to tune the hydrophilicity of these sites by introduction of thiophene-2,5-dicarboxylate (TDC²⁻) along with PZDC²⁻ in the MOF backbone. Based on these two linkers, nine multivariate PT-MOFs, formulated as [Al(OH)(PZDC)₁₋ₓ(TDC)ₓ], covering the entire linker mixing range (x=0, 0.125, 0.25, 0.375, 0.5, 0.625, 0.75, 0.875, 1; FIG. 1a-c) were produced. These compounds have been made under both solvothermal and reflux-based conditions, and their structure, composition, and porosity were fully characterized. The power of the multivariate strategy is revealed by the water sorption behavior exhibited by this PT-MOF series, where it is possible to (i) tune and access a broader range of relative humidity at which the MOF operates, and (ii) provide for a more energetically efficient water-harvesting process, as evidenced by lower regeneration temperatures and heats. These two findings far exceed what has already been reported and is suitable for water harvesting at arid conditions.^{16,17} Additionally, we demonstrate the scalability of these multivariate compounds to the kilogram scale in water and with excellent space-time yields using readily available starting materials.

In this example we disclose a new multivariate MOF-303-based water-harvesting framework series from readily available reactants is developed. The resulting MOFs exhibit a larger degree of tunability in operational relative humidity range (16%), regeneration temperature (14° C.), and desorption enthalpy (5 kJ mol⁻¹) than reported previously. Additionally, a high-yielding (≥90%) and scalable (˜3.5 kg) synthesis is demonstrated in water and with excellent space-time yields, without compromising framework crystallinity, porosity, and water-harvesting performance.

Design Considerations and Synthesis. When considering the choice of the second linker for the MOF-303-based multivariate framework series, its availability and level of hydrophobicity are important factors. Additionally, the angle between the carboxylic acid groups has to be similar to enable crystallization of both linkers in the same crystal lattice and avoid formation of a mixture of single-linker MOFs (FIG. 1a-c).¹⁸ Based on a search in the Cambridge Chemical Database using the Mogul software,^{19,20} the angle between the carboxylic acid groups of protonated, uncoordinated H₂TDC is 147.7(17)°, thus exhibiting a deviation of 10° in comparison to H₂PZDC. This difference seems to be significant enough to result in single-linker MOFs of different topology, space group, and with secondary building units (SBUs) of different stereochemistry.^{9,21,22}

MOF-303 crystallizes in the monoclinic space group P2₁/c and its rod-like SBU consists of cis-trans-alternating corned-shared AlO₆ octahedra.⁹ On the other hand, CAU-23, [Al(OH)(TDC)], is reported in the orthorhombic space group P2₁2₁2 with its SBU comprising (cis)₄-(trans)₄-alternating corned-shared AlO₆ octahedra (FIG. 1b, c).²¹ Despite these structural differences, solvothermal synthesis of a multivariate MOF series covering the entire range of linker mixing ratios including the two single-linker frameworks MOF-303 and CAU-23 was carried out under aqueous conditions. The nomenclature PTnm, which describes the molar input ratio of H₂PZDC to H₂TDC (n to m), will be used in the following to refer to the respective materials.

Structural and Compositional Characterization. Dependent on the linker ratio utilized in the synthesis, formation of two different phases was discovered using powder X-ray diffraction (PXRD) analysis of the synthesized multivariate PT-MOF series. Interestingly, at most of the input ratios of H₂PZDC (PT80 to PT26), phases isostructural to MOF-303 were observed, while only the compounds generated at low input ratios of H₂PZDC (PT17 and PT08) exhibited CAU-23-like structures.

The composition of the multivariate PT-MOFs was probed using NMR spectroscopy, elemental analysis (EA), and scanning electron microscopy (SEM) coupled with energy dispersive X-ray spectroscopy (EDS). Prior to subjecting the samples to NMR spectroscopy, the MOFs were thoroughly washed, and then fully base-hydrolyzed using concentrated NaOD solution. Furthermore, the H₂PZDC content was extracted from EA of activated MOF samples by using the N to S ratio. Both NMR and EA indicated formulaic behavior of the bulk PT-MOF samples, where the observed output ratio of H₂PZDC was proportional to the input ratio of the respective linker. The presence of both linkers in the same crystallites was confirmed using SEM-EDS measurements on separated crystals of all members of the multivariate PT-MOF series as well as larger portions of the sample materials. EDS signals associated with Al, O, and C were observed in all crystallites, while the N signal diminished and the S signal increased with higher incorporation ratios of the TDC²⁻ linker. If present, both the N and S signals uniformly resembled the crystal outlines, thus indicating homogenous distribution of both linkers within the multivariate PT-MOFs. Interestingly, for some separated crystals, one could also observe different crystal morphologies when comparing the SEM micrographs of the MOF-303-like phase and the CAU-23-like phase.

Thermal Stability and Porosity. Next, the thermal stability and porosity of the multivariate compounds were probed using thermogravimetric analysis (TGA) and nitrogen sorption analysis, respectively. Interestingly, all multivariate compounds isostructural to MOF-303 (PT80 to PT26) exhibited no weight loss up to −400° C. under both argon and air atmosphere, while PT17 and PT08 displayed a slightly earlier onset of decomposition at both conditions (˜375° C.). The BET surface areas and specific pore volumes decreased continuously from 1370 to 1220 m² g⁻¹ and from 0.50 to 0.45 cm³ g⁻¹, respectively, with increasing incorporation of TDC²⁻ into the MOF structure, as one would expect considering the molecular weight difference between PZDC²⁻ and TDC²⁻. The pore sizes were approximated to lie in the same range for all nine compounds (9.4-9.6 Å), as anticipated for frameworks constructed from linker molecules of similar length and in absence of dangling side chains restricting the pore diameters.

Control of the Humidity Cut-Off. The step of the water sorption isotherms of the multivariate PT-MOFs was shifted from 12% RH for PT80 (MOF-303) to 27% RH for PT08 (CAU-23). Thus, with the combination of these two linkers, the tuning range was extended 50% compared to our previously reported multivariate MOF system.¹⁷ The gravimetric water uptake capacity decreased from 0.45 to 0.42 g g⁻¹, which can, similarly to the BET surface areas and specific pore volumes, be ascribed to the molecular weight difference between the two linkers. Only a minimal degree of hysteresis was observed for these MOFs, which is an important prerequisite for energy efficient atmospheric water harvesting. Interestingly, the structural type of the framework impacted the water sorption isotherm profile: While the CAU-23-type frameworks exhibited steep isotherm profiles, the compounds isostructural to MOF-303 displayed more gradual and shallow uptakes, leading to the step position of PT26 at 28% being shifted to more hydrophobic values than PT08.

Tuning of the Heat of Adsorption. Additional water sorption data was collected on all compounds at 15 and 35° C., which indicated consistent behavior across different temperatures. These data were used to estimate the differential enthalpies of adsorption ⊏h_{ads} using the Clausius-Clapeyron equation. The respective average values Δ̅h̅_̅{̅a̅d̅s̅}̅ exhibited an impressive increase from −54 to −49 kJ mol⁻¹ across the multivariate MOF series. Considering that the heat of condensation of water at 25° C. is −44 kJ mol⁻¹, this corresponds to a decrease of the heat of adsorption penalty by a substantial 50%.

Modulation of the Regeneration Temperature. Furthermore, the multivariate approach allowed for a significant lowering of the desorption temperatures, as was estimated using water vapor desorption isobar measurements. At 1.70 kPa water vapor pressure, the desorption temperature could be shifted more than 14° C. using the multivariate approach (Table S7). The trends in steepness and step positions between the water sorption isotherm profiles of the MOF-303-type and the CAU-23-type structures also translated to their isobaric curves, such that the isobaric curve of PT26 exhibited its desorption step at lower temperatures than PT08 but simultaneously required larger temperatures for complete desorption.

Development of Scalable Synthetic Routes with High Space-Time Yields. Typically, the synthesis of MOF-303 was conducted at 1.5 base equivalents through unperturbed incubation of the reaction mixture in an isothermal oven overnight.⁹ Employing these conditions to prepare multivariate MOFs resulted, at some linker mixing ratios, in compounds that exhibited water sorption isotherms with large hysteresis loops, which could only be removed through longer incubation times (2-4 days). At the same time, the yields have never exceeded 50%, which was directly related to the base stoichiometry utilized during the synthesis (Table S1). Theoretically, to achieve quantitative yields of the compounds herein, one would require 3 base equivalents—2 for the full deprotonation of the dicarboxylic acid linker and 1 for the formation of the SBU. However, employing this base stoichiometry under solvothermal conditions resulted in MOFs with a substantial number of defects, as indicated by non-ideal water sorption isotherms, which was likely related to insufficient equilibration under these unperturbed conditions. Finally, the solvothermal procedure was not scalable, thus preventing its practical use in an industrial setting.

To account for the aforementioned points, a reflux-based synthesis method under stirring and in presence of 3 base equivalents was established (FIG. 2). With this method, the reaction times could be reduced to a total of 5 hours and the yields were improved to ≥90% (Table Si), thus leading to space-time yield increases of two orders of magnitude for all multivariate PT-MOFs (Table S2). The products, referred to as PTnm-HY (HY, high yield), exhibited high crystallinity, as was verified by PXRD analysis, and proportionality between linker input and output ratios according to NMR spectroscopy and EA. The BET surface areas, estimated by using nitrogen sorption analysis, were comparable to the frameworks prepared under solvothermal condition (1230-1370 m² g⁻¹). Importantly, the water sorption isotherm profiles indicated the same degree of tunability and similar water uptake capacities.

Time-Dependent Product Formation. Surprisingly, different products were obtained at a linker input ratio of 2 to 6 (H₂PZDC to H₂TDC) as a function of the reaction time. While PT26 prepared with the solvothermal procedure was isostructural to MOF-303, strikingly, the PXRD pattern of PT26-HY indicated a CAU-23-type structure. Formation of a product with a linker output ratio deviating from the input ratio, hinting at the formation of not fully equilibrated compounds, could be excluded by NMR spectroscopy and EA (Table S3). To further corroborate this observation, a series of compounds, termed PT26-HY-xh (x, refluxing time in hours), was prepared using different reaction times. Indeed, with increasing refluxing time, formation of a MOF-303-type product was prevalent, while the output linker ratios for all multivariate PT26-HY-xh compounds were constant at all reaction times (Table S3). This behavior was further reflected in the step position and steepness of the respective water sorption isotherm profiles and water desorption isobar profiles, suggesting that PT26-HY-3h would be more suitable for water harvesting under arid conditions than PT26-HY-40h, but would also require higher regeneration temperatures.

Scale-Up Synthesis of Multivariate MOFs. Encouraged by the promising results achieved through the reflux-based synthesis in a flask, the procedure was adapted to a 200 L-reaction vessel (FIG. 3). This approach provided ˜3.5 kg of activated MOF per reaction batch within 8 hours, thus resulting in more than doubling of the space-time yields compared to the flask-based synthesis (Table S2). The products were highly crystalline, exhibited formulaic behavior pertaining to the linker output ratios, and displayed high BET surface areas in the range of 1120-1390 m² g⁻¹. Similar to the products obtained on a small scale, water sorption analysis revealed high tunability and water uptake capacities for these multivariate MOFs prepared at scale.

The invention provides a multivariate MOF system based on readily available starting materials. The resulting frameworks displayed an even broader range of tunability in the humidity range of atmospheric moisture uptake, regeneration temperature, and enthalpies of adsorption. Taken together, these advancements provide a more energy efficient, versatile water-harvesting system under arid conditions. Importantly, a synthesis procedure for these MOFs was developed to allow for their facile production at kilogram scale, using water as a solvent, with high space-time yields, and without major compromises to their water-harvesting performance. Overall, this invention enables commercialization of the water-harvesting technology and the integration of these materials in large-scale atmospheric moisture extraction units to generate practical amounts of water anytime and anywhere.

### REFERENCES

(1) United Nations. The United Nations World Water Development Report 2021: Valuing Water; UNESCO: Paris, 2021.
(2) Mekonnen, M. M.; Hoekstra, A. Y. Four Billion People Facing Severe Water Scarcity. Sci. Adv. 2016, 2 (2), e1500323.
(3) United Nations. Sustainable Development Goal 6: Synthesis Report on Water and Sanitation; New York, 2018.
(4) Elmer, T. H.; Hyde, J. F. Recovery of Water from Atmospheric Air in Arid Climates. Sep. Sci. Technol. 1986, 21 (3), 251-266.
(5) Hanikel, N.; Prévot, M. S.; Yaghi, O. M. MOF Water Harvesters. Nat. Nanotechnol. 2020, 15 (5), 348-355.
(6) Furukawa, H.; Gandara, F.; Zhang, Y.-B.; Jiang, J.; Queen, W. L.; Hudson, M. R.; Yaghi, O. M. Water Adsorption in Porous Metal-Organic Frameworks and Related Materials. J. Am. Chem. Soc. 2014, 136 (11), 4369-4381.
(7) Kim, H.; Yang, S.; Rao, S. R.; Narayanan, S.; Kapustin, E. A.; Furukawa, H.; Umans, A. S.; Yaghi, O. M.; Wang, E. N. Water Harvesting from Air with Metal-Organic Frameworks Powered by Natural Sunlight. Science 2017, 356 (6336), 430-434.
(8) Kim, H.; Rao, S. R.; Kapustin, E. A.; Zhao, L.; Yang, S.; Yaghi, O. M.; Wang, E. N. Adsorption-Based Atmospheric Water Harvesting Device for Arid Climates. Nat. Commun. 2018, 9 (1), 1191.
(9) Fathieh, F.; Kalmutzki, M. J.; Kapustin, E. A.; Waller, P. J.; Yang, J.; Yaghi, O. M. Practical Water Production from Desert Air. Sci. Adv. 2018, 4 (6), eaat3198.
(10) Hanikel, N.; Prévot, M. S.; Fathieh, F.; Kapustin, E. A.; Lyu, H.; Wang, H.; Diercks, N. J.; Glover, T. G.; Yaghi, O. M. Rapid Cycling and Exceptional Yield in a Metal-Organic Framework Water Harvester. ACS Cent. Sci. 2019, 5 (10), 1699-1706.
(11) Yilmaz, G.; Meng, F. L.; Lu, W.; Abed, J.; Peh, C. K. N.; Gao, M.; Sargent, E. H.; Ho, G. W. Autonomous Atmospheric Water Seeping MOF Matrix. Sci. Adv. 2020, 6 (42), 1-9.
(12) Xu, W.; Yaghi, O. M. Metal-Organic Frameworks for Water Harvesting from Air, Anywhere, Anytime. ACS Cent. Sci. 2020, 6 (8), 1348-1354.
(13) Deng, H.; Doonan, C. J.; Furukawa, H.; Ferreira, R. B.; Towne, J.; Knobler, C. B.; Wang, B.; Yaghi, O. M. Multiple Functional Groups of Varying Ratios in Metal-Organic Frameworks. Science 2010, 327 (5967), 846-850.
(14) Viciano-Chumillas, M.; Liu, X.; Leyva-Pdrez, A.; Armentano, D.; Ferrando-Soria, J.; Pardo, E. Mixed Component Metal-Organic Frameworks: Heterogeneity and Complexity at the Service of Application Performances. Coord. Chem. Rev. 2022, 451, 214273.
(15) Furukawa, H.; Müller, U.; Yaghi, O. M. “Heterogeneity within Order” in Metal-Organic Frameworks. Angew. Chemie Int. Ed. 2015, 54 (11), 3417-3430.
(16) Schlisener, C.; Xhinovci, M.; Ernst, S.-J.; Schmitz, A.; Tannert, N.; Janiak, C. Solid-Solution Mixed-Linker Synthesis of Isoreticular Al-Based MOFs for an Easy Hydrophilicity Tuning in Water-Sorption Heat Transformations. Chem. Mater. 2019, 31 (11), 4051-4062.
(17) Hanikel, N.; Pei, X.; Chheda, S.; Lyu, H.; Jeong, W.; Sauer, J.; Gagliardi, L.; Yaghi, O. M. Evolution of Water Structures in Metal-Organic Frameworks for Improved Atmospheric Water Harvesting. Science 2021, 374 (6566), 454-459.
(18) Schlusener, C.; Jordan, D. N.; Xhinovci, M.; Matemb Ma Ntep, T. J.; Schmitz, A.; Giesen, B.; Janiak, C. Probing the Limits of Linker Substitution in Aluminum MOFs through Water Vapor Sorption Studies: Mixed-MOFs Instead of Mixed-Linker CAU-23 and MIL-160 Materials. Dalt. Trans. 2020, 49 (22), 7373-7383.
(19) Groom, C. R.; Bruno, I. J.; Lightfoot, M. P.; Ward, S. C. The Cambridge Structural Database. Acta Crystallogr. Sect. B Struct. Sci. Cryst. Eng. Mater. 2016, 72 (2), 171-179.
(20) Bruno, I. J.; Cole, J. C.; Kessler, M.; Luo, J.; Motherwell, W. D. S.; Purkis, L. H.; Smith, B. R.; Taylor, R.; Cooper, R. I.; Harris, S. E.; Orpen, A. G. Retrieval of Crystallographically-Derived Molecular Geometry Information. J. Chem. Inf Comput. Sci. 2004, 44 (6), 2133-2144.
(21) Lenzen, D.; Zhao, J.; Ernst, S.-J.; Wahiduzzaman, M.; Ken Inge, A.; Frdhlich, D.; Xu, H.; Bart, H.-J.; Janiak, C.; Henninger, S.; Maurin, G.; Zou, X.; Stock, N. A Metal-Organic Framework for Efficient Water-Based Ultra-Low-Temperature-Driven Cooling. Nat. Commun. 2019, 10 (1), 3025.
(22) Tschense, C. B. L.; Reimer, N.; Hsu, C.; Reinsch, H.; Siegel, R.; Chen, W.; Lin, C.; Cadiau, A.; Serre, C.; Senker, J.; Stock, N. New Group 13 MIL-53 Derivates Based on 2,5-Thiophenedicarboxylic Acid. Zeitschriftfir Anorg. und Allg. Chemie 2017, 643 (21), 1600-1608.

### Synthesis of Metal-Organic Frameworks Under Solvothermal Conditions

The solvothermal synthesis conditions were adapted from our previous report:²

In a 20 mL vial, a mixture (0.5 mmol) of H₂PZDC and H₂TDC was fully dissolved in aqueous NaOH solution (0.079 M, 9.5 mL, 1.5 eq.). The mole ratio of H₂PZDC to H₂TDC (n to m) was adjusted to prepare multivariate MOFs, and the materials prepared from the linker mixtures are denoted as PTnm (P, H₂PZDC; T, H₂TDC; n, mole ratio of H₂PZDC; m, mole ratio of H₂TDC). Afterwards, aqueous AlCl₃ solution (1 M, 0.5 mL) was added and the resulting clear mixture was incubated for 2-4 days in a pre-heated oven at 100° C. The obtained white solid was washed with deionized water (3×15 mL) and methanol (3×15 mL) over a period of one day each. Next, the MOF was dried under dynamic vacuum (˜10-3 mbar) and heated to 120° C. over a period of 6 hours to yield the pure, activated product (47-53 mg, 47-50%).

The synthesis of PT26 had to be modified by increasing the base stoichiometry to obtain a single-phase product.

In a 20 mL vial, a mixture of H₂PZDC. H₂O (21.8 mg, 0.125 mmol) and H₂TDC (64.5 mg, 0.375 mmol) was fully dissolved in aqueous NaOH solution (0.132 M, 9.5 mL, 2.5 eq.). Afterwards, aqueous AlCl₃ solution (1 M, 0.5 mL) was added, resulting in the formation of a white precipitate. The reaction mixture was then incubated for 4 days in a pre-heated oven at 100° C. The obtained white solid was washed with deionized water (3×15 mL) and methanol (3×15 mL) over a period of one day each. Next, the MOF was dried under dynamic vacuum (˜10-3 mbar) and heated to 120° C. over a period of 6 hours to yield the pure, activated product (82 mg, 78%).

The washed and activated compounds were subjected to elemental analysis. The calculated formula for the elemental microanalysis results is given based on the input linker mole ratio:

Element. Anal. of activated PT80: Calcd. for C₄₀H₂₄Al₈N₁₆O₄₀: C, 30.32; H, 1.53; Al, 13.62; N, 14.15; 0, 40.39 wt %; Found: C, 29.61; H, 1.68; N, 13.22 wt %.

Element. Anal. of activated PT71: Calcd. for C₄₁H₂₄Al₈N₁₄O₄₀S₁: C, 30.76; H, 1.51; Al, 13.48; N, 12.25; 0, 39.98; S, 2.00 wt %; Found: C, 30.82; H, 1.69; N, 12.12; S, 1.76 wt %.

Element. Anal. of activated PT62: Calcd. for C₄₂H₂₄Al₈N₁₂O₄₀S₂: C, 31.20; H, 1.50; Al, 13.35; N, 10.40; 0, 39.59; S, 3.96 wt %; Found: C, 31.58; H, 1.67; N, 10.19; S, 3.82 wt %.

Element. Anal. of activated PT53: Calcd. for C₄₃H₂₄Al₈N₁₀O₄₀S₃: C, 31.63; H, 1.48; Al, 13.22; N, 8.58; 0, 39.20; S, 5.88 wt %; Found: C, 31.42; H, 1.60; N, 8.55; S, 5.56 wt %.

Element. Anal. of activated PT44: Calcd. for C₄₄H₂₄Al₈N₈O₄₀S₄: C, 32.05; H, 1.47; Al, 13.09; N, 6.80; 0, 38.82; S, 7.76 wt %; Found: C, 32.18; H, 1.53; N, 6.48; S, 7.64 wt %.

Element. Anal. of activated PT35: Calcd. for C₄₅H₂₄Al₈N₆O₄₀S₅: C, 32.47; H, 1.46; Al, 12.97; N, 5.05; 0, 38.45; S, 9.61 wt %; Found: C, 32.60; H, 1.54; N, 4.66; S, 9.81 wt %.

Element. Anal. of activated PT26: Calcd. for C₄₆H₂₄Al₈N₄O₄₀S₆: C, 32.87; H, 1.44; Al, 12.84; N, 3.33; 0, 38.08; S, 11.42 wt %; Found: C, 33.20; H, 1.59; N, 3.48; S, 11.54 wt %.

Element. Anal. of activated PT17: Calcd. for C₄₇H₂₄Al₈N₂O₄₀S₇: C, 33.27; H, 1.43; Al, 12.72; N, 1.65; 0, 37.72; S, 13.20 wt %; Found: C, 33.30; H, 1.37; N, 0.81; S, 14.09 wt %.

Element. Anal. of activated PT08: Calcd. for C₄₈H₂₄Al₈O₄₀S₈: C, 33.66; H, 1.42; Al, 12.60; 0, 37.37; S, 14.95 wt %; Found: C, 33.32; H, 1.43; S, 15.11 wt %.

### Synthesis of Metal-Organic Frameworks Under Reflux Conditions in a Round-Bottom Flask

In a 250 mL round-bottom flask, a mixture (10 mmol) of H₂PZDC and H₂TDC was fully dissolved in aqueous NaOH solution (0.6 M, 50 mL). The mole ratio of H₂PZDC to H₂TDC (n to m) was adjusted to prepare multivariate MOFs, and the materials prepared from the linker mixtures are denoted as PTnm-HY (P, H₂PZDC; T, H₂TDC; n, mole ratio of H₂PZDC; m, mole ratio of H₂TDC; HY, high yield). AlCl₃·6H₂O (2.41 g, 10 mmol) was dissolved in 50 mL deionized water and added dropwise to the linker solution in the round-bottom flask at room temperature under vigorous stirring. The total addition time was 2 hours, resulting in the formation of a white precipitate. The reaction mixture was then heated to 120° C., and refluxed for 3 hours at all linker mixing ratios. For PT26-HY, the refluxing time was varied between 3 and 40 hours, and the respective samples are labeled PT26-HY-xh (P, H₂PZDC; T, H₂TDC; HY, high yield; x, refluxing time in hours). After the solution cooled down to room temperature, the resulting white powder was collected by centrifugation and washed twice with deionized water. The white solid was subsequently washed three times with EtOH and dried under air overnight. Full activation of the MOF was conducted under dynamic vacuum (˜10-3 mbar) at 120° C. for 24 hours, yielding pure and desolvated product (1.86-2.01 g, 90-96%).

The washed and activated compounds were subjected to elemental analysis. The calculated formula for the elemental analysis results is given based on the input linker mole ratio:

Element. Anal. of activated PT80-HY: Calcd. for C₄₀H₂₄Al₈N₁₆O₄₀: C, 30.32; H, 1.53; Al, 13.62; N, 14.15; 0, 40.39 wt %; Found: C, 29.88; H, 1.53; N, 13.27 wt %.

Element. Anal. of activated PT71-HY: Calcd. for C₄₁H₂₄AlN₁₄O₄₀S₁: C, 30.76; H, 1.51; Al, 13.48; N, 12.25; 0, 39.98; S, 2.00 wt %; Found: C, 29.73; H, 1.72; N, 11.84; S, 1.84 wt %.

Element. Anal. of activated PT62-HY: Calcd. for C₄₂H₂₄Al₈N₁₂O₄₀S₂: C, 31.20; H, 1.50; Al, 13.35; N, 10.40; 0, 39.59; S, 3.96 wt %; Found: C, 30.87; H, 1.56; N, 10.11; S, 3.64 wt %.

Element. Anal. of activated PT53-HY: Calcd. for C₄₃H₂₄Al₈N₁₀O₄₀S₃: C, 31.63; H, 1.48; Al, 13.22; N, 8.58; 0, 39.20; S, 5.88 wt %; Found: C, 30.11; H, 1.83; N, 8.28; S, 5.49 wt %.

Element. Anal. of activated PT44-HY: Calcd. for C₄₄H₂₄Al₈N₈O₄₀S₄: C, 32.05; H, 1.47; Al, 13.09; N, 6.80; 0, 38.82; S, 7.76 wt %; Found: C, 30.72; H, 1.71; N, 6.74; S, 7.39 wt %.

Element. Anal. of activated PT35-HY: Calcd. for C₄₅H₂₄Al₈N₆O₄₀S₅: C, 32.47; H, 1.46; Al, 12.97; N, 5.05; 0, 38.45; S, 9.61 wt %; Found: C, 30.79; H, 1.68; N, 5.05; S, 9.08 wt %.

Element. Anal. of activated PT26-HY/PT26-HY-3h: Calcd. for C₄₆H₂₄Al₈N₄O₄₀S₆: C, 32.87; H, 1.44; Al, 12.84; N, 3.33; 0, 38.08; S, 11.42 wt %; Found: C, 32.61; H, 1.42; N, 3.27; S, 11.22 wt %.

Element. Anal. of activated PT26-HY-4h: Calcd. for C₄₆H₂₄Al₈N₄O₄₀S₆: C, 32.87; H, 1.44; Al, 12.84; N, 3.33; 0, 38.08; S, 11.42 wt %; Found: C, 32.61; H, 1.47; N, 3.14; S, 11.33 wt %.

Element. Anal. of activated PT26-HY-8h: Calcd. for C₄₆H₂₄Al₈N₄O₄₀S₆: C, 32.87; H, 1.44; Al, 12.84; N, 3.33; 0, 38.08; S, 11.42 wt %; Found: C, 32.69; H, 1.57; N, 3.51; S, 11.19 wt %.

Element. Anal. of activated PT26-HY-16h: Calcd. for C₄₆H₂₄Al₈N₄O₄₀S₆: C, 32.87; H, 1.44; Al, 12.84; N, 3.33; 0, 38.08; S, 11.42 wt %; Found: C, 32.51; H, 1.56; N, 3.53; S, 11.13 wt %.

Element. Anal. of activated PT26-HY-20h: Calcd. for C₄₆H₂₄Al₈N₄O₄₀S₆: C, 32.87; H, 1.44; Al, 12.84; N, 3.33; 0, 38.08; S, 11.42 wt %; Found: C, 32.61; H, 1.42; N, 3.44; S, 11.44 wt %.

Element. Anal. of activated PT26-HY-28h: Calcd. for C₄₆H₂₄Al₈N₄O₄₀S₆: C, 32.87; H, 1.44; Al, 12.84; N, 3.33; 0, 38.08; S, 11.42 wt %; Found: C, 32.61; H, 1.43; N, 3.38; S, 11.04 wt %.

Element. Anal. of activated PT26-HY-40h: Calcd. for C₄₆H₂₄Al₈N₄O₄₀S₆: C, 32.87; H, 1.44; Al, 12.84; N, 3.33; 0, 38.08; S, 11.42 wt %; Found: C, 32.01; H, 1.61; N, 3.59; S, 10.93 wt %.

Element. Anal. of activated PT17-HY: Calcd. for C₄₇H₂₄Al₈N₂O₄₀S₇: C, 33.27; H, 1.43; Al, 12.72; N, 1.65; 0, 37.72; S, 13.20 wt %; Found: C, 33.12; H, 1.53; N, 1.81; S, 12.99 wt %.

Element. Anal. of activated PT08-HY: Calcd. for C₄₈H₂₄Al₈O₄₀S₈: C, 33.66; H, 1.42; Al, 12.60; 0, 37.37; S, 14.95 wt %; Found: C, 33.30; H, 1.41; S, 14.91 wt %.

### Synthesis of Metal-Organic Frameworks Under Reflux Conditions in a Reaction Vessel

In a 200 L glass reaction vessel, a mixture of H₂PZDC and H₂TDC (20 mol), as well as NaOH (2.4 kg, 60 mol) were dissolved in 38 L deionized water. The mole ratio of H₂PZDC to H₂TDC (n to m) was adjusted to prepare multivariate MOFs. The materials synthesized from these linker mixtures are denoted as PTnm-HYS (P, H₂PZDC; T, H₂TDC; n, mole ratio of H₂PZDC; m, mole ratio of H₂TDC; HYS, high yield and scale). The resulting suspension was stirred for 60 minutes until all the solids dissolved completely and the solution cooled down to room temperature. Afterwards, AlCl₃·6H₂O (4.82 kg, 20 mol) was dissolved in 12 L deionized water and transferred to a 15 L glass material-feeding funnel. The aluminum chloride solution was added at a rate of 6 L per hour to the reaction vessel with the spinner rotating at 100 rpm. The total addition time lasted for 2 hours, resulting in the formation of a white precipitate. Next, the temperature of the heating jacket was set to be 120° C., thus heating the reaction mixture to 100° C. After refluxing for 6 hours and letting the reaction mixture cool down to 60° C., the solid product was collected in a 20 L filtration funnel and washed with 15 L aqueous 70% EtOH (v/v) solution. For further purification, the white powder was subsequently redispersed by stirring in 30 L anhydrous EtOH at room temperature, followed by filtration and drying under air overnight. The obtained white powder was placed in a 120° C. oven for 48 hours to yield pure and desolvated product (3.50-3.61 kg, 84-91%).

The washed and activated compounds were subjected to elemental analysis. The calculated formula for the elemental analysis results is given based on the input linker mole ratio:

Element. Anal. of activated PT80-HYS: Calcd. for C₄₀H₂₄Al₈N₁₆O₄₀: C, 30.32; H, 1.53; Al, 13.62; N, 14.15; 0, 40.39 wt %; Found: C, 29.77; H, 1.58; N, 13.40 wt %.

Element. Anal. of activated PT62-HYS: Calcd. for C₄₂H₂₄Al₈N₁₂O₄₀S₂: C, 31.20; H, 1.50; Al, 13.35; N, 10.40; 0, 39.59; S, 3.96 wt %; Found: C, 30.82; H, 1.67; N, 9.75; S, 3.84 wt %.

Element. Anal. of activated PT44-HYS: Calcd. for C₄₄H₂₄Al₈N₈O₄₀S₄: C, 32.05; H, 1.47; Al, 13.09; N, 6.80; 0, 38.82; S, 7.76 wt %; Found: C, 31.23; H, 1.58; N, 6.22; S, 8.11 wt %.

Element. Anal. of activated PT26-HYS: Calcd. for C₄₆H₂₄Al₈N₄O₄₀S₆: C, 32.87; H, 1.44; Al, 12.84; N, 3.33; 0, 38.08; S, 11.42 wt %; Found: C, 33.08; H, 1.72; N, 2.94; S, 11.33 wt %.

Element. Anal. of activated PT08-HYS: Calcd. for C₄₈H₂₄Al₈O₄₀S₈: C, 33.66; H, 1.42; Al, 12.60; 0, 37.37; S, 14.95 wt %; Found: C, 33.62; H, 1.48; S, 14.95 wt %.

TABLE S1
Comparison of the yields (in g and %) achieved for the multivariate
PT-MOF series by employing different synthesis methods.

| | | Yield (g) | | |
|---|---|---|---|---|
| | | | | Reflux in |
| | | | Reflux in | reaction |
| MOF | | Solvothermal | flask (HY) | vessel (HYS) |
| PT80 | | 0.049 (49%) | 1.87 (94%) | 3590 (91%) |
| PT71 | | 0.047 (47%) | 1.92 (91%) | N/A |
| PT62 | | 0.048 (48%) | 1.86 (92%) | 3540 (88%) |
| PT53 | | 0.049 (48%) | 1.96 (96%) | N/A |
| PT44 | | 0.049 (48%) | 1.91 (93%) | 3500 (85%) |
| PT35 | | 0.049 (47%) | 1.88 (90%) | N/A |
| PT26 | PT26-3 h | 0.082 (78%)^{†} | 1.91 (91%) | 3610 (86%) |
| | PT26-4 h | | 2.01 (96%) | |
| | PT26-8 h | | 1.98 (94%) | |
| | PT26-16 h | | 1.97 (94%) | |
| | PT26-20 h | | 1.99 (95%) | |
| | PT26-28 h | | 1.90 (90%) | |
| | PT26-40 h | | 1.99 (95%) | |

| | | | |
|---|---|---|---|
| PT17 | 0.052 (49%) | 1.89 (90%) | N/A |
| PT08 | 0.053 (50%) | 1.93 (90%) | 3610 (84%) |

^{†}To achieve a single-phase PT26 sample under solvothermal conditions, the base stoichiometry had to be increased from 1.5 to 2.5 equivalents, which led to a higher yield.

TABLE S2
Comparison of the space-time yields achieved for the multivariate
PT-MOF series by employing different synthesis methods.

Space-time yield (kg m⁻³ day⁻¹)

| | | | Reflux in |
|---|---|---|---|
| | | Reflux in | reaction |
| MOF | Solvothermal | flask (HY) | vessel (HYS) |

| PT80 | | 1.6 | 89.8 | 215 |
|---|---|---|---|---|
| PT71 | | 1.6 | 92.2 | N/A |
| PT62 | | 1.6 | 89.3 | 212 |
| PT53 | | 1.6 | 94.1 | N/A |
| PT44 | | 1.6 | 91.7 | 210 |
| PT35 | | 1.6 | 90.2 | N/A |
| PT26 | PT26-3 h | 2.7^{†} | 91.7 | 217 |
| | PT26-4 h | | 80.4 | |
| | PT26-8 h | | 47.5 | |
| | PT26-16 h | | 26.3 | |
| | PT26-20 h | | 21.7 | |
| | PT26-28 h | | 15.2 | |
| | PT26-40 h | | 11.4 | |

| | | | |
|---|---|---|---|
| PT17 | 1.7 | 90.7 | N/A |
| PT08 | 1.8 | 92.6 | 217 |

^{†}To achieve a single-phase PT26 sample under solvothermal conditions, the base stoichiometry had to be increased from 1.5 to 2.5 equivalents, which led to a higher space-time yield.

TABLE S3
Summary of the composition assessment of the multivariate PT-MOF series
(synthesized by employing different procedures and reaction times)
with help of 1H-nuclear magnetic resonance (NMR) spectroscopy and elemental
analysis (EA). The observed H2PZDC ratio was determined from EA under
consideration of the obtained nitrogen to sulfur ratio.

| | | | Observed H₂PZDC ratio (%) | | | | | |
|---|---|---|---|---|---|---|---|---|
| | | | | | Reflux | | Reflux in | |
| | | Input | | | in flask | | reaction vessel | |
| | | H₂PZDC | Solvothermal | | (HY) | | (HYS) | |
| MOF | | ratio (%) | NMR | EA | NMR | EA | NMR | EA |
| PT80 | | 100 | 100 | 100 | 100 | 100 | 100 | 100 |
| PT71 | | 87.5 | 91.3 | 86.6 | 87.3 | 84.5 | N/A | |
| PT62 | | 75 | 79.4 | 72.8 | 75.8 | 72.2 | 73.2 | 69.6 |
| PT53 | | 62.5 | 64.7 | 61.1 | 63.1 | 59.1 | N/A | |
| PT44 | | 50 | 49.4 | 46.3 | 49.6 | 48.1 | 46.9 | 44.4 |
| PT35 | | 37.5 | 34.8 | 33.3 | 37.5 | 36.1 | N/A | |
| PT26 | PT26-3 h | 25 | 24.2 | 24.9 | 24.9 | 25.8 | 21.9 | 21.0 |
| | PT26-4 h | | | | 24.8 | 25.0 | | |
| | PT26-8 h | | | | 24.7 | 24.0 | | |
| | PT26-16 h | | | | 25.1 | 25.6 | | |
| | PT26-20 h | | | | 25.3 | 26.0 | | |
| | PT26-28 h | | | | 25.0 | 25.9 | | |
| | PT26-40 h | | | | 25.0 | 27.3 | | |

| PT17 | 12.5 | 6.1 | 5.8 | 12.4 | 12.9 | N/A | |
|---|---|---|---|---|---|---|---|
| PT08 | 0 | 0 | 0 | 0 | 0 | 0 | 0 |

TABLE S4
Summary of the BET surface areas obtained from nitrogen
sorption analysis on the multivariate PT-MOF series.
Standard deviations are expressed in brackets in
terms of the least significant digit(s).

| | | BET surface area (m² g⁻¹) | | | | | |
|---|---|---|---|---|---|---|---|
| | | | | | | Reflux in | |
| | | | | Reflux in | | reaction | |
| MOF | | Solvothermal | | flask (HY) | | vessel (HYS) | |
| PT80 | | 1372.0 | (4) | 1374 | (3) | 1392 | (4) |
| PT71 | | 1369.4 | (12) | 1278.8 | (12) | N/A | |
| PT62 | | 1358.7 | (15) | 1292.9 | (18) | 1120.4 | (14) |
| PT53 | | 1337.6 | (15) | 1275.7 | (16) | N/A | |
| PT44 | | 1283.4 | (18) | 1255.0 | (10) | 1260.9 | (13) |
| PT35 | | 1271.4 | (16) | 1229.4 | (17) | N/A | |
| PT26 | PT26-3 h | 1260.2 | (18) | 1266 | (2) | 1170.1 | (5) |
| | PT26-4 h | | | 1279 | (3) | | |
| | PT26-8 h | | | 1199 | (2) | | |
| | PT26-16 h | | | 1201 | (2) | | |
| | PT26-20 h | | | 1213 | (4) | | |
| | PT26-28 h | | | 1222.0 | (13) | | |
| | PT26-40 h | | | 1252.2 | (13) | | |

| PT17 | 1237.3 | (3) | 1249.8 | (11) | N/A | |
|---|---|---|---|---|---|---|
| PT08 | 1217.4 | (4) | 1275.1 | (12) | 1182.3 | (15) |

TABLE S5
Summary of the pore volume and size estimations from the nitrogen
sorption analysis of the multivariate PT-MOF series. It should
be noted that the single-point pore volume assessment at P/P0 =
0.95 likely overestimates the pore volume due to some degree of
intracrystalline condensation occurring at this pressure range.

| | Pore volume (single-point at | Pore volume (DFT) | Pore size |
|---|---|---|---|
| MOF | P/P₀ = 0.95) (cm³ g⁻¹) | (cm³ g⁻¹) | (DFT) (Å) |
| PT80 | 0.519 | 0.498 | 9.4 |
| PT71 | 0.524 | 0.503 | 9.4 |
| PT62 | 0.527 | 0.503 | 9.4 |
| PT53 | 0.535 | 0.498 | 9.6 |
| PT44 | 0.509 | 0.479 | 9.5 |
| PT35 | 0.519 | 0.473 | 9.4 |
| PT26 | 0.515 | 0.470 | 9.4 |
| PT17 | 0.511 | 0.457 | 9.5 |
| PT08 | 0.498 | 0.453 | 9.6 |

TABLE S6
Summary of water sorption isotherm measurements on the
multivariate PT-MOF series. The position of the isotherm
step was determined at 50% of the total uptake . . .

| | Position of the isotherm step | Δ̅h̅_̅{̅a̅d̅s̅}̅ |
|---|---|---|
| MOF | (at 25° C.) (% RH) | (kJ mol⁻¹) |
| PT80 | 11.8 | −54.2 |
| PT71 | 12.6 | −52.7 |
| PT62 | 14.8 | −52.5 |
| PT53 | 17.3 | −50.6 |
| PT44 | 21.1 | −50.5 |
| PT35 | 24.6 | −51.3 |
| PT26 | 27.5 | −49.4 |
| PT17 | 25.4 | −48.6 |
| PT08 | 26.6 | −49.4 |

TABLE S7
Summary of the results from the water vapor isobar measurements
on PT80, PT62, PT44, PT26, PT08, PT26-HY-3 h, and PT26-
HY-40 h at water vapor pressures of 1.27-1.70 kPa Noteworthy,
the MOF-303-like frameworks PT26 and PT26-HY-40 h exhibit
a similar isobar step position.

Temperature of isobar step at
respective water vapor pressure (° C.)

| MOF | 1.27 kPa | 1.70 kPa |
|---|---|---|
| PT80 | 49.8 | 53.0 |
| PT62 | 44.3 | 47.8 |
| PT44 | 37.5 | 41.9 |
| PT26 | 36.0 | 38.9 |
| PT08 | 36.7 | 40.2 |
| PT26-HY-3 h | 37.7 | 41.7 |
| PT26-HY-40 h | 35.6 | 38.8 |

### SUPPLEMENTAL REFERENCES

(1) Micromeritics Instruments Corporation. MicroActive. Norcross, GA, USA 2018.
(2) Hanikel, N.; Pei, X.; Chheda, S.; Lyu, H.; Jeong, W.; Sauer, J.; Gagliardi, L.; Yaghi, O. M. Evolution of Water Structures in Metal-Organic Frameworks for Improved Atmospheric Water Harvesting. Science 2021, 374 (6566), 454-459.
(3) Lenzen, D.; Zhao, J.; Ernst, S.-J.; Wahiduzzaman, M.; Ken Inge, A.; Fröhlich, D.; Xu, H.; Bart, H.-J.; Janiak, C.; Henninger, S.; Maurin, G.; Zou, X.; Stock, N. A Metal-Organic Framework for Efficient Water-Based Ultra-Low-Temperature-Driven Cooling. Nat. Commun. 2019, 10 (1), 3025.
(4) Campbell, C. T.; Sellers, J. R. V. Enthalpies and Entropies of Adsorption on Well-Defined Oxide Surfaces: Experimental Measurements. Chem. Rev. 2013, 113 (6), 4106-4135.
(5) Kim, H.; Cho, H. J.; Narayanan, S.; Yang, S.; Furukawa, H.; Schiffres, S.; Li, X.; Zhang, Y.-B.; Jiang, J.; Yaghi, O. M.; Wang, E. N. Characterization of Adsorption Enthalpy of Novel Water-Stable Zeolites and Metal-Organic Frameworks. Sci. Rep. 2016, 6 (1), 19097.

### Example: Green Synthesis and Scale-Up of MOFs for Water Harvesting from Air

In this example, we disclose a facile, sustainable, and high-yield synthesis method to produce a series of water-harvesting MOFs, including MOF-303, CAU-23, MIL-160, MOF-313, CAU-10, and Al-fumarate. Using readily available reactants and water as the only solvent, we were able to synthesize these materials at the kilogram scale in a 200 L batch reactor with yields of 84-96% and space-time yields of 238-305 kg/day/m³ under optimized reaction conditions. We also show that our procedure preserves framework crystallinity, porosity, and water-harvesting performance of the MOFs synthesized at scale.

Water scarcity is a major global challenge, with over half the world's population experiencing shortages of this vital resource^{1,2}. The temporal and spatial variation in the distribution of available water resources on this planet and the lack of transportation and supplement infrastructure make fresh water even more precious in some arid regions^{3,4}. Fortunately, the use of sorbent-assisted atmospheric water harvesting devices has been proposed as a promising solution to address this issue. These devices use porous solid sorbents to trap water molecules at low relative humidity (RH) and release them with minimal energy expenditure⁵⁻⁸. Since this approach is neither spatially nor temporally restricted, the supplement of fresh water by the water harvesting device equipped with desirable sorbents can be achieved at any location and at any time of the year^{7,9}. However, the development of suitable porous materials for use in these devices, particularly for household use and widespread accessibility, has been a challenge. In addition to having excellent water sorption properties, a desirable sorbent should be scalable, cost-effective, and reproducible in manufacturing in order to be practical for use in various complex real-world conditions⁹⁻¹¹.

Microporous metal-organic frameworks (MOFs) have recently gained attention due to their high tunability, unprecedented variety, and intrinsic porosity, and have been successfully employed in desert water harvesting^{5,6,10,12-15}. While a significant body of work has been created in developing MOF sorbents with tailored capacity and isotherm shape, it has largely been limited to small-scale proof of concepts and there are few reports on the large-scale synthesis of water harvesting MOFs for industrial use¹⁶¹⁸. On the other hand, it was proposed that the concept of green synthesis methods using water as a solvent can address the challenges of high production cost and environmental hazards in the industrial-scale synthesis of MOFs₁₉₋₂₁ As such, our group has previously developed a green, scalable, and cost-effective method for the synthesis of aluminum-based MOFs on a kilogram scale using inexpensive and readily available starting materials^{22,23}.

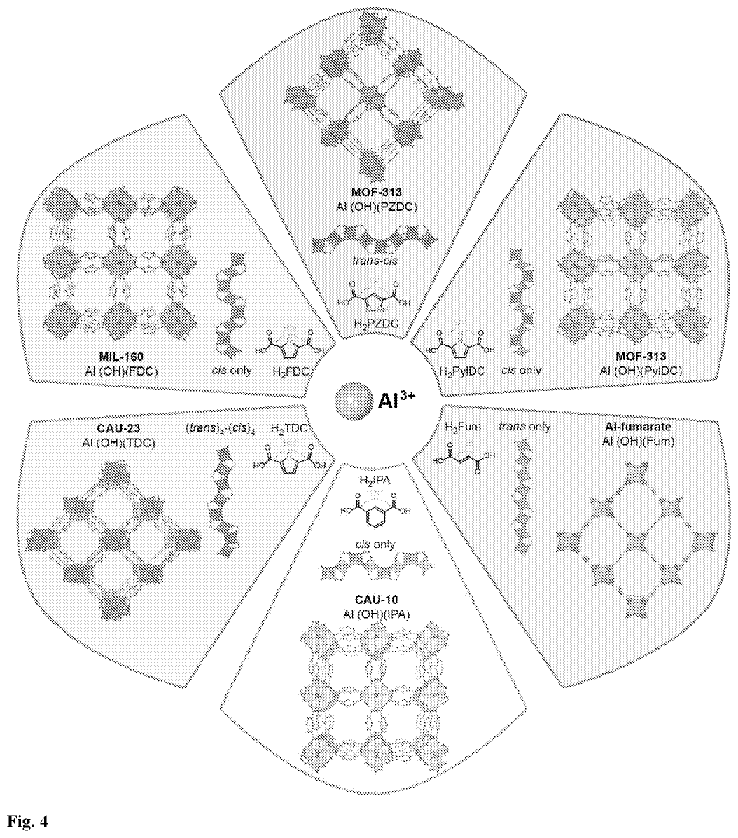

In this example, we further demonstrate that our large-scale, green, and facile production route is generalizable to the synthesis of a series of important water harvesting MOFs (FIG. 4), including MOF-303 | Al(OH)(PZDC), PZDC²⁻=1-H-pyrazole-3,5-dicarboxylate |¹³, CAU-23 [Al(OH)(TDC), TDC²⁻=thiophene-2,5-dicarboxylate]²⁴, MIL-160 [Al(OH)(FDC), FDC²⁻=furan-2,5,-dicarboxylate]²⁵, MOF-313 [Al(OH)(2,5-PylDC), 2,5-PylDC²⁻ =pyrrole-2,5-dicarboxylate]^{26,27}, Al-fumarate [Al(OH)(Fum), Fum²⁻=furmarate]^{28,29}, and CAU-10 [Al(OH)(IPA), IPA²⁻=1,4-benzenedicarboxylate]³⁰. With this facile water-based synthesis method, each MOF can be produced up to several kilograms per batch, and the materials retain their crystallinity, porosity, and water uptake upon scaling up.

Starting Materials and General Procedures. Bulk (40 kg) 1H-pyrazole-3,5-dicarboxylic acid (H₂PZDC·H₂O, purity ≥95%), AlCl₃·6H₂O (purity ≥99%) and Al₂(SO₄)₃·18H₂O (purity ≥98%) were purchased from Aaron Chemicals LLC. Bulk (10 kg) 2,5-thiophenedicarboxylic acid (H₂TDC, purity ≥98%) was purchased from Ambeed Inc. Bulk (5 kg) 2,5-furandicarboxylic acid (H₂FDC, purity ≥98%), isophthalic acid (purity ≥98%), and fumaric acid (purity ≥98%) were purchased from Arctom Chemicals LLC. Bulk (20 kg) sodium hydroxide pellets (NaOH, purity ≥97%) was purchased from Oakwood Products, Inc. Bulk ethanol (EtOH, purity ≥99.8%) was purchased from Sigma Aldrich. 1H-Pyrrole-2,5-dicarboxylic acid (H₂PylDC, purity ≥98%) was purchased from Aaron Chemicals LLC. Deuterated solvents were obtained from Cambridge Isotope Laboratories. Ultrahigh-purity (UHP) grade (99.999%) argon and nitrogen were obtained from Praxair. All starting materials and solvents were used without further purification.

Prior to the analysis and characterization, the MOF samples were washed with H₂O and ethanol, and evacuated at room temperature for 1 h and at 120° C. for an additional 12 h. To analyze the linker composition of the MOF compounds with NMR spectroscopy, the activated sample was fully hydrolyzed using a NaOD solution (10% in D₂O). ¹H-NMR spectra were acquired on Bruker NEO-500 MHz spectrometers, and elemental analysis (EA) was performed on a PerkinElmer 2400 Series II CHNS elemental analyzer at the NMR facility and Microanalytical Laboratory of the College of Chemistry, University of California, Berkeley. Thermal gravimetric analysis (TGA) curves were taken using a TA Q500 thermal analysis system with a heating rate of 5° C./min under N₂ flow. Powder X-ray diffraction (PXRD) patterns were recorded using a Rigaku MiniFlex 6G equipped with a HyPix-400MF Hybrid Pixel Array detector and a normal focus X-ray tube with a Cu-source (k=1.54178 Å). Nitrogen sorption experiments were conducted using a Micromeritics Accelerated Surface Area and Porosimetry (ASAP) 2420 System. During the measurement, the sample was cooled to 77 K in a liquid nitrogen bath. Water vapor sorption experiments were carried out on a BEL Japan BELSORP-aqua or a Micromeritics 3Flex Surface Characterization Analyzer. The water vapor source was degassed through five freeze-pump-thaw cycles before the analysis. An isothermal water bath was employed to keep the sample temperature during the measurements.

General Preparation of MOF Materials. MOF-303, Al(OH)(PZDC). The synthesis of MOF-303 was adopted from our previous reports^{22,34}. In a 200 L glass reaction vessel equipped with a heating jacket, a mixture of H₂PZDC·H₂O (3.48 kg, 20 mol) and NaOH (2.4 kg, 60 mol) were dissolved in 38 L deionized water. The resulting solution was stirred for 60 minutes until all the solids were completely dissolved and the solution cooled down to room temperature. Next, in a 20 L beaker, AlCl₃·6H₂O (4.82 kg, 20 mol) was dissolved in 12 L deionized water and transferred to a 15 L glass material-feeding funnel. The 12 L aluminum chloride solution was slowly added to the 38 L linker solution in the vessel at a rate of 6 L per hour with vigorous stirring. The total addition time lasted 2 hours, and the white precipitate formed during the addition. Afterward, the temperature of the heating jacket was set to 120° C., thus heating the reaction mixture to 100° C. After refluxing for 6 hours and letting the reaction mixture cool down to 60° C., the white solid product was collected in a 20 L filtration funnel. For purification, the white powder was subsequently redispersed by stirring in 15 L aqueous 70% EtOH (v/v) solution, filtered off, and washed again with 30 L anhydrous EtOH at room temperature, followed by filtration and drying under air overnight. The obtained white powder was placed in a 120° C. oven for 48 hours to yield the pure and desolvated product (3.61 kg, 91% based on the linker). Elemental analysis for the activated sample of MOF-303: Calcd. for A1C₅H₃N₂O₅═Al(OH)(PZDC): C, 30.32; H, 1.53; N, 14.14 wt %; Found: C, 29.77; H, 1.58; N, 13.40 wt %.

CAU-23, Al(OH)(TDC). In a 200 L glass reaction vessel equipped with a heating jacket, a mixture of H₂TDC (3.44 kg, 20 mol) and NaOH (2.4 kg, 60 mol) were dissolved in 38 L deionized water. The resulting solution was stirred for 60 minutes until all the solids were completely dissolved and the solution cooled down to room temperature. Next, in a 20 L beaker, AlCl₃·6H₂O (4.82 kg, 20 mol) was dissolved in 12 L deionized water and transferred to a 15 L glass material-feeding funnel. The 12 L aluminum chloride solution was slowly added to the 38 L linker solution in the vessel at a rate of 6 L per hour with vigorous stirring. The total addition time lasted 2 hours, and the white precipitate formed during the addition. Afterward, the temperature of the heating jacket was set to 120° C., thus heating the reaction mixture to 100° C. After refluxing for 6 hours and letting the reaction mixture cool down to 60° C., the white solid product was collected in a 20 L filtration funnel. For purification, the white powder was subsequently redispersed by stirring in 15 L aqueous 70% EtOH (v/v) solution, filtered off, and washed again with 30 L anhydrous EtOH at room temperature, followed by filtration and drying under air overnight. The obtained white powder was placed in a 120° C. oven for 48 hours to yield the pure and desolvated product (3.50 kg, 84% based on the linker). Elemental analysis for the activated sample of CAU-23: Calcd. for AlC₆H₃SO₅═Al(OH)(TDC): C, 33.66; H, 1.41; N, 37.36; S, 14.97 wt %; Found: C, 33.62; H, 1.48; S, 14.95 wt %.

MIL-160, Al(OH)(FDC). In a 200 L glass reaction vessel equipped with a heating jacket, a mixture of H₂FDC (3.12 kg, 20 mol) and NaOH (2.4 kg, 60 mol) were dissolved in 40 L deionized water. The resulting solution was stirred for 60 minutes until all the solids were completely dissolved and the solution cooled down to room temperature. Next, in a 20 L beaker, AlCl₃·6H₂O (4.82 kg, 20 mol) was dissolved in 10 L deionized water and transferred to a 15 L glass material-feeding funnel. The 10 L aluminum chloride solution was slowly added to 40 L linker solution in the vessel at a rate of 5 L per hour with vigorous stirring. The total addition time lasted 2 hours, and the white precipitate formed during the addition. Afterward, the temperature of the heating jacket was set to 120° C., thus heating the reaction mixture to 100° C. After refluxing for 6 hours and letting the reaction mixture cool down to 60° C., the white solid product was collected in a 20 L filtration funnel. For purification, the white powder was subsequently redispersed by stirring in 15 L aqueous 70% EtOH (v/v) solution, filtered off, and washed again with 30 L anhydrous EtOH at room temperature, followed by filtration and drying under air overnight. The obtained white powder was placed in a 120° C. oven for 48 hours to yield the pure and desolvated product (3.64 kg, 92% based on the linker). Elemental analysis for the activated sample of MIL-160: Calcd. for A1C₆H₃O₆═Al(OH)(FDC): C, 36.38; H, 1.53 wt %; Found: C, 36.49; H, 1.48 wt %.

MOF-313, Al(OH)(2,5-PylDC). In a 1 L glass round bottom flask, a mixture of H₂PylDC (31 g, 0.2 mol) and NaOH (24 g, 0.6 mol) were dissolved in 0.4 L deionized water. The resulting solution was stirred for 10 minutes until all the solids were completely dissolved. Next, AlCl₃·6H₂O (48.2 g, 0.2 mol) was dissolved in 0.1 L deionized water and added to the round bottom flask dropwise with vigorous stirring. The total addition time lasted 2 hours, and the white precipitate formed during the addition. Afterward, the reaction mixture was heated to 120° C. After refluxing for 6 hours and letting the reaction mixture cool down to room temperature, the white solid product was collected by centrifugation. For purification, the white powder was washed twice with deionized water and subsequently washed three times with EtOH. The white solid was air-dried overnight. Full activation of the MOF was conducted in vacuo at 120° C. for 24 hours, yielding pure and desolvated product (38 g, 96% based on the linker). Elemental analysis for the activated sample of MOF-313: Calcd. for AlC₆H₄O₅N═Al(OH)(2,5-PylDC): C, 36.57; H, 2.05; N, 7.11 wt %; Found: C, 36.55; H, 2.04; N, 6.26 wt %.

Al-fumarate, Al(OH)(Fum). In a 200 L glass reaction vessel equipped with a heating jacket, a mixture of fumaric acid (2.32 kg, 20 mol) and NaOH (2.4 kg, 60 mol) were dissolved in 26 L deionized water. The resulting solution was stirred for 60 minutes until all the solids were completely dissolved and the solution cooled down to room temperature. Next, AlCl₃·6H₂O (4.82 kg, 20 mol) was dissolved in 24 L deionized water and divided into two equal portions. The first portion (12 L) was transferred to a 15 L glass material-feeding funnel and subsequently added to the 26 L linker solution in the vessel slowly at a rate of 12 L per hour with vigorous stirring. The procedure was then repeated for the second portion of the aluminum chloride solution. The total addition time lasted for 2 hours, and the white precipitate formed during the addition. Afterward, the temperature of the heating jacket was set to 110° C., thus heating the reaction mixture to 100° C. After refluxing for 6 hours and letting the reaction mixture cool down to room temperature, the white solid product was collected in a 20 L filtration funnel. For purification, the white powder was subsequently redispersed by stirring in 15 L aqueous 70% EtOH (v/v) solution, filtered off, and washed again with 30 L anhydrous EtOH at room temperature, followed by filtration and drying in air overnight. The obtained white powder was placed in a 120° C. oven for 48 hours to yield the pure and desolvated product (2.97 kg, 94% based on the linker). Elemental analysis for the activated sample of Al-fumarate: Calcd. for AlC₄H₃O₅═Al(OH)(Fum): C, 30.40; H, 1.91 wt %; Found: C, 30.28; H, 1.95 wt %.

CAU-10, Al(OH)(IPA). In a 200 L glass reaction vessel equipped with a heating jacket, a mixture of isophthalic acid (3.32 kg, 20 mol) and NaOH (2.4 kg, 60 mol) were dissolved in 26 L deionized water. The resulting solution was stirred for 60 minutes until all the solids were completely dissolved and the solution cooled down to room temperature. Next, Al₂(SO₄)₃·18H₂O (6.67 kg, 10 mol) was dissolved in 24 L deionized water and divided into two equal portions. The first portion (12 L) was transferred to a 15 L glass material-feeding funnel and subsequently added to the 26 L linker solution in the vessel slowly at a rate of 12 L per hour with vigorous stirring. The procedure was then repeated for the second portion of the aluminum sulfate solution. The total addition time lasted 2 hours, and the white precipitate formed during the addition. Afterward, the temperature of the heating jacket was set to 130° C., thus heating the reaction mixture to 100° C. After refluxing for 6 hours and letting the reaction mixture cool down to room temperature, the white solid product was collected in a 20 L filtration funnel. For purification, the white powder was subsequently redispersed by stirring in 15 L deionized water, filtered off, and washed again with 3×15 L anhydrous EtOH at room temperature, followed by filtration and drying in air overnight. The obtained white powder was placed in a 120° C. oven for 48 hours to yield the pure and desolvated product (3.81 kg, 92% based on the linker). Elemental analysis for the activated sample of CAU-10: Calcd. for A1C₄H₃O₅═Al(OH)(IPA): C, 46.17; H, 2.42 wt %; Found: C, 45.85; H, 2.35 wt %; see, Table 1.

The synthesis scale, condition, and yield of a series of water-harvesting MOFs are summarized in Table 1. In up-scale MOF synthesis, important considerations include linker and metal availability, purity of chemicals, raw material costs, the toxicity of reagents, reaction time, reaction yield, and safety^{20,43}. As shown in Experimental Methods and Materials, all six MOFs were prepared from commercially available and relatively cheap linkers and aluminum salts. While linkers purchased in bulk usually have a lower purity (90-95%), it should be noted that if impurities do not react with A3 in aqueous solution, it will not affect the quality of the MOF product. On the other hand, minimizing the amount of organic solvent used (DMF) is essential when transferring syntheses from the small laboratory to the technical scale, as they are toxic and harmful to the environment and account for a large proportion of the manufacturing cost^{16,20,44}. Consequently, we chose water as the solvent and used enough base to fully deprotonate the linker to increase its solubility.

To overcome the low yield and long incubation time associated with traditional solvothermal synthesis of MOFs, we developed a reflux-based synthesis method with vigorous stirring to allow sufficient reaction equilibrium in a faster manner (6 h). This method also allows for higher concentrations compared to unperturbed solvothermal synthesis, resulting in a 2-fold increase in space-time-yield³⁴. More importantly, while the solvothermal synthesis is not scalable, the reflux method is highly scalable and can be adapted for use in an industrial setting. As such, we first optimized the synthesis conditions in a small laboratory setting (100 mL round-bottom-flask with oil bath)²², and then adapt the procedure to a scale-up setting (200 L reaction vessel with heated jacket) for further optimizations.

During the optimization of the reaction parameters for the synthesis of six aluminum-based MOFs with rod SBUs [Al(L)(OH), where L is the deprotonated linker such as PZDC²⁻, TDC²⁻, and FDC²⁻], we found that using exactly three equivalents of NaOH was key to maximizing the yield. Two equivalents of NaOH were used for the full deprotonation of the dicarboxylic acid linker, and one equivalent was used for the formation of the SBU. It is worth noting that, although the formation of high crystalline product can be achieved in a short period of time (1 h), we kept the mixture under reflux for 6 h in kilogram-scale synthesis with a large solvent volume to achieve full porosity and water uptake and minimize undesirable hysteresis in the water isotherm. Using these optimized conditions, we were able to produce approximately 3 kg of activated MOF per batch with a high yield and good water uptake, which are comparable to results from gram-scale synthesis reported in the literature^{6,10,16,26,35}.

The crystallinity of the scaled-up MOF products was investigated by PXRD measurements. The measured values were in good agreement with the simulation data for each MOF. It should be noted that all materials, after washing, showed high crystallinity, with significant peaks that could be well indexed. This suggests that the scale-up method, with a suitable refluxing time, does not result in a loss of crystallinity for the MOF materials.

The composition of the six MOFs was analyzed using NMR spectroscopy and elemental analysis. After activation, five of them show only one singlet peak from the corresponding dicarboxylate linker in the range of 6.3 to 7.2 ppm in their ¹H digestion NMR. CAU-10 showed three peaks from its IPA linker in the range of 7.4 to 8.1 ppm in its ¹H digestion NMR. In all six H NMR spectra, the peaks of washing solvent EtOH were not present, indicating that MOFs were fully activated, and no solvent remained. These results confirm the high purity of all MOFs synthesized at scale. In addition, the good agreement between the calculated and found elemental compositions of all MOF samples indicates that all impurities were removed and no water or EtOH was left in the activated MOFs.

Next, the permanent porosity of the aluminum MOF series was investigated using nitrogen sorption analysis. The Brunauer-Emmett-Teller (BET) surface areas and specific pore volumes of the compounds ranged from 1379 to 654 m²/g and 0.47 to 0.23 cm³/g, respectively. These results are comparable to literature data^{6,10,16,26,35}, and demonstrate that all scaled-up MOF samples had optimal BET surface areas, pore diameters, and pore volumes (Table S1). The thermal stability of these MOFs was also evaluated using TGA, and they showed no weight loss up to −400° C. under nitrogen atmospheres.

Finally, we measured the water vapor sorption isotherms of the scaled-up MOF products at 25° C. All samples showed a consistent S-shaped profile with different steps and water uptake capacities (Table S2). MOF-303 had an inflection point at 12% RH and the highest gravimetric water capacity of 39 wt % at 40% RH among all six MOFs. This can be attributed to its highest pore volume among the MOFs. CAU-23 had an inflection point at 26% RH and water capacity of 33 wt % at 40% RH, which was due to the hydrophobic nature of TDC linker. MIL-160 had the lowest inflection point at 7% RH and gravimetric water capacity of 36 wt % due to its hydrophilic pore environment. MOF-313 had an inflection point at 13% RH and a gravimetric water capacity of 34 wt %, as for MOF-303. CAU-10 had an inflection point at 17% RH and a gravimetric water capacity of 32 wt % because of its smaller pore volume established by bulkier IPA linker. Al-fumarate had an inflection point at 27% RH and the gravimetric water capacity of 39 wt %. For most samples, only a small degree of hysteresis was observed between the adsorption and desorption curves, indicating that the optimal conditions (e.g. reaction time, reaction temperature, etc.) minimized the number of defective sites within the crystal lattice. These results show that the water isotherm behavior of all six aluminum-based MOFs prepared at kilogram scale is comparable to that reported at gram or milligram scale in the literature, and our synthesis method leads to high-quality water harvesting MOF materials at scale.

In this example, we demonstrated that a series of important water harvesting MOFs (MOF-303, CAU-23, MIL-160, MOF-313, CAU-10, and Al-fumarate) can be synthesized under industrially suitable, green conditions using inexpensive, commercially available linkers. Our facile and robust synthesis method led to production of MOFs at the kilogram scale without compromising framework crystallinity, porosity, or water-harvesting properties. These results demonstrate the feasibility of commercializing MOFs as water-harvesting sorbents and will contribute to the widespread adoption of water-harvesting technologies.

### REFERENCES

1. Bagheri, F. Performance investigation of atmospheric water harvesting systems. Water Resour. Ind. 20, 23-28 (2018).
2. Mekonnen, M. M. & Hoekstra, A. Y. Four billion people facing severe water scarcity. Sci. Adv. 2, e1500323 (2016).
3. Oelkers, E. H., Hering, J. G. & Zhu, C. Water: is there a global crisis? Elements 7, 157-162 (2011).
4. Shannon, M. A. et al. Science and technology for water purification in the coming decades. Nanoscience and technology: a collection of reviews from nature Journals, 337-346 (2010).
5. Furukawa, H. et al. Water adsorption in porous metal-organic frameworks and related materials. J. Am. Chem. Soc. 136, 4369-4381 (2014).
6. Kim, H. et al. Adsorption-based atmospheric water harvesting device for arid climates. Nat. Commun. 9, 1-8 (2018).
7. Xu, W. & Yaghi, 0. M. Metal-organic frameworks for water harvesting from air, anywhere, anytime. ACS Cent. Sci. 6, 1348-1354 (2020).
8. Zhou, X., Lu, H., Zhao, F. & Yu, G. Atmospheric water harvesting: a review of material and structural designs. ACS Mater. Lett. 2, 671-684 (2020).
9. Hanikel, N., Prévot, M. S. & Yaghi, O. M. MOF water harvesters. Nat. Nanotechnol. 15, 348-355 (2020).
10. Hanikel, N. et al. Rapid cycling and exceptional yield in a metal-organic framework water harvester. ACS Cent. Sci. 5, 1699-1706 (2019).
11. Yang, P., Clark, D. S. & Yaghi, O. M. Envisioning the “Air Economy”—Powered by Reticular Chemistry and Sunlight for Clean Air, Clean Energy, and Clean Water. Mol. Front. J. 5, 30-37 (2021).
12. Kim, H. et al. Water harvesting from air with metal-organic frameworks powered by natural sunlight. Science 356, 430-434 (2017).
13. Fathieh, F. et al. Practical water production from desert air. Sci. Adv. 4, eaat3198 (2018).
14. Yilmaz, G. et at. Autonomous atmospheric water seeping MOF matrix. Sci. Adv. 6, eabc8605 (2020).
15. Burtch, N. C., Jasuja, H. & Walton, K. S. Water stability and adsorption in metal-organic frameworks. Chem. Rev. 114, 10575-10612 (2014).
16. Lenzen, D. et al. Scalable green synthesis and full-scale test of the metal-organic framework CAU-10-H for use in adsorption-driven chillers. Adv. Mater. 30, 1705869 (2018).
17. Kim, S.-N., et al. Pilot-scale synthesis of a zirconium-benzenedicarboxylate UiO-66 for CO2 adsorption and catalysis. Catal. Today 245, 54-60 (2015).
18. Rubio-Martinez, M. et al. Scalability of continuous flow production of metal-organic frameworks. ChemSusChem 9, 938-941 (2016).
19. DeSantis, D. et al. Techno-economic analysis of metal-organic frameworks for hydrogen and natural gas storage. Energy Fuels 31, 2024-2032 (2017).
20. Gaab, M., Trukhan, N., Maurer, S., Gummaraju, R. & Müller, U. The progression of Al-based metal-organic frameworks—From academic research to industrial production and applications. Microporous Mesoporous Mater. 157, 131-136 (2012).
21. Khabzina, Y. et al. Synthesis and shaping scale-up study of functionalized UiO-66 MOF for ammonia air purification filters. Ind. Eng. Chem. Res. 57, 8200-8208 (2018).
22. Zheng, Z., et al., Broadly Tunable Atmospheric Water Harvesting in Multivariate Metal-Organic Frameworks. J. Am. Chem. Soc. 144, 22669-22675 (2022).
23. Zheng, Z. et al. High-yield, green and scalable methods for producing MOF-303 for water harvesting from desert air. Nat. Protoc. 18, 136-156 (2023).
24. Lenzen, D. et al. A metal-organic framework for efficient water-based ultra-low-temperature-driven cooling. Nat. Commun. 10, 1-9 (2019).
25. Cadiau, A. et al. Design of hydrophilic metal organic framework water adsorbents for heat reallocation. Adv. Mater. 27, 4775-4780 (2015).
26. Cho, K. H. et al. Rational design of a robust aluminum metal-organic framework for multi-purpose water-sorption-driven heat allocations. Nat. Commun. 11, 1-8 (2020).
27. Yaghi, O. M., Hanikel, N. & Hao, L. Multivariate and other metal-organic frameworks, and uses thereof. U.S. Patent No. 62/771,537, University of California (2020).
28. Leung, E. et al. Process for preparing porous metal-organic frameworks based on aluminum fumarate. U.S. Pat. No. 8,524,932, BASF SE patent (2013).
29. Kiener, C., Müller, U. & Schubert, M. Method of using a metal organic frameworks based on aluminum fumarate. (2013).
30. Reinsch, H. et al. Structures, sorption characteristics, and nonlinear optical properties of a new series of highly stable aluminum MOFs. Chem. Mater. 25, 17-26 (2013).
31. Alvarez, E. et al. The structure of the aluminum fumarate metal-organic framework A520. Angew. Chem. 127, 3735-3739 (2015).
32. Fröhlich, D. et al. Water adsorption behaviour of CAU-10-H: a thorough investigation of its structure-property relationships. J. Mater. Chem. A 4, 11859-11869 (2016).
33. Hanikel, N. et al. Evolution of water structures in metal-organic frameworks for improved atmospheric water harvesting. Science 374, 454-459 (2021).
34. Zheng, Z. et al. High-yield, green and scalable methods for producing MOF-303 for water harvesting from desert air. Nat. Protoc., 1-21 (2022).
35. Tannert, N., et al. Robust synthesis routes and porosity of the Al-based metal-organic frameworks Al-fumarate, CAU-10-H and MIL-160. Dalton Trans. 48, 2967-2976 (2019).
36. Lenzen, D. et al. A metal-organic framework for efficient water-based ultra-low-temperature-driven cooling. Nat. Commun. 10, 3025 (2019).
37. Lee, J. S. et al. Porous metal-organic framework CUK-1 for adsorption heat allocation toward green applications of natural refrigerant water. ACS Appl. Mater. Interfaces 11, 25778-25789 (2019).
38. Zhao, T. et al. High-yield, fluoride-free and large-scale synthesis of MIL-101 (Cr). Dalton Trans. 44, 16791-16801 (2015).
39. Sohail, M. et al. Synthesis of highly crystalline NH2-MIL-125 (Ti) with S-shaped water isotherms for adsorption heat transformation. Cryst. Growth Des. 17, 1208-1213 (2017).
40. Permyakova, A. et al. Synthesis Optimization, Shaping, and Heat Reallocation Evaluation of the Hydrophilic Metal-Organic Framework MIL-160 (Al). ChemSusChem 10, 1419-1426 (2017).
41. Wang, S. et al. A robust large-pore zirconium carboxylate metal-organic framework for energy-efficient water-sorption-driven refrigeration. Nat. Energy 3, 985-993 (2018).
42. Rieth, A. J., et al. Record atmospheric fresh water capture and heat transfer with a material operating at the water uptake reversibility limit. ACS Cent. Sci. 3, 668-672 (2017).
43. Czaja, A., Leung, E., Trukhan, N. & Müller, U. Industrial MOF synthesis. Metal-Organic Frameworks: Applications from Catalysis to Gas Storage, 337-352 (2011).
44. Reinsch, H. M. et al., Chem. Mater 25, 17-26 (2013).

TABLE S1
Summary of the results from the nitrogen sorption analysis on the
water-harvesting MOF series. Standard deviations (where available)
are expressed in brackets in terms of the least significant digit.

| | BET | Pore volume | Pore size |
|---|---|---|---|
| | surface area | calculated by | calculated by |
| MOF | (m²/g) | DFT (cm³/g) | DFT (Å) |
| MOF-303 | 1379(1) | 0.471 | 9.54 |
| CAU-23 | 1176(2) | 0.450 | 9.68 |
| MIL-160 | 1030(2) | 0.381 | 9.54 |
| MOF-313 | 1033(4) | 0.405 | 9.40 |
| CAU-10 | 654(2) | 0.239 | 10.01 |
| Al-fumarate | 1108(4) | 0.410 | 9.84 |

TABLE S2
Summary of the results from the water sorption
isotherms on the water-harvesting MOF series.

| MOF | Step (% RH) | Capacity (g/g) |
|---|---|---|
| MOF-303 | 12 | 0.39 |
| CAU-23 | 26 | 0.33 |
| MIL-160 | 7 | 0.36 |
| MOF-313 | 13 | 0.34 |
| CAU-10 | 17 | 0.32 |
| Al-fumarate | 27 | 0.39 |

TABLE 1
Comparison of synthesis scale of water-harvesting MOFs

| | | | | Dry MOF | | | |
|---|---|---|---|---|---|---|---|
| | | | | obtained | | | |
| | | Solvent and | | per batch | Yield^{(d)} | Space-time-yield | |
| MOF | Composition^{(a)} | volume^{(b)} | Conditions | (g) | (%) | (kg · day⁻¹ · m⁻³ ·) | Reference |
| Al- | Al(OH)(Fum) | H₂O (50 L) | Reflux, 6 h | 2970 | 94 | 238 | this work |
| fumarate | | H₂O (0.01 L) | 60° C., 2 h | 0.4 | 74 | 436 | 35 |
| CAU-10 | Al(OH)(IPA) | H₂O (50 L) | Reflux, 6 h | 3810 | 92 | 305 | this work |
| | | H₂O (8.19 L), | Reflux, 10 h | 500^{(c)} | 93 | 139 | 16 |
| | | EtOH (0.42 L) | | | | | |
| CAU-23 | Al(OH)(TDC) | H₂O (50 L) | Reflux, 6 h | 3610 | 84 | 289 | this work |
| | | H₂O (0.13 L) | Reflux, 6 h | 5 | 84 | 154 | 36 |
| Co-CUK-1 | Co₃(OH)₂(2,4-PDC)₂ | H₂O (0.004 L) | 200° C., 15 h | 0.2 | 67 | 80 | 37 |
| MIL-101-Cr | Cr₃O(OH)(BDC)₃ | H₂O (2.4 L) | 200° C., 15 h | 127 | 68 | 85 | 38 |
| MIL-125-NH₂ | Ti₈O₈(OH)₄(BDC-NH₂)₆ | DMF (0.05 L), | 110° C., 5 h | 4 | 94 | 320 | 39 |
| | | MeOH (0.01 L) | | | | | |
| MIL-160 | Al(OH)(FDC) | H₂O (50 L) | Reflux, 6 h | 3640 | 92 | 291 | this work |
| | | H₂O (1 L) | Reflux, 24 h | 130^{(c)} | 93 | 130 | 40 |
| MIP-200 | Zr₆O₄(OH)₄(MDIP)₂(HCOO)₄ | Ac₂O (0.035 L), | 120° C., 48 h | 1 | 96 | 7 | 41 |
| | | HCOOH (0.025 L) | | | | | |
| MOF-303 | Al(OH)(PZDC) | H₂O (50 L) | Reflux, 6 h | 3590 | 91 | 287 | this work |
| | | H₂O (0.75 L) | 100° C., 24 h | 3 | 35 | 4 | 13 |
| MOF-313 | Al(OH)(2,5-PylDC) | H₂O (0.5 L) | Reflux, 6 h | 38 | 96 | 304 | this work |
| | | H₂O (0.05 L) | Reflux, 12 h | 2 | 93 | 80 | 26 |
| | | H₂O (0.005 L) | 100° C., 2 h | 0.01 | 7 | 24 | 27 |
| MOF-801 | Zr₆O₄(OH)₄(HCOO)₆ | DMF (0.04 L), | 130° C., 10 h | 2 | 25 | 96 | 13 |
| | | HCOOH (0.01 L) | | | | | |
| MOF-841 | Zr₆O₄(OH)₄(MTB)₂(HCOO)₄ | DMF (0.04 L), | 130° C., 48 h | 0.1 | 55 | 0.8 | 5 |
| | | HCOOH (0.02 L) | | | | | |
| Ni-BTDD | Ni₂Cl₂(BTDD) | DMF (0.2 L), | 65° C., 10 d | 0.3 | 87 | 0.1 | 42 |
| | | EtOH (0.2 L) | | | | | |
| UiO-66 | Zr₆O₄(OH)₄(BDC)₆ | DMF (60 L) | 115° C., 24 h | 1560^{(c)} | 93 | 26 | 17 |

^{(a)}Formula excluding guests.
Abbreviations:
Fum = fumarate, IPA = 1,3-benzenedicarboxylate (isophthalate), TDC = thiophene-2,5-dicarboxylate, 2,4-PDC = pyridine-2,4-dicarboxylate, BDC = benzene-1,4-dicarboxylate, BDC-NH₂ = 2-amine-1,4-benzenedi-carboxylate, FDC = furan-2,5,-dicarboxylate, MDIP = methylene-diisophthalate, HCOO⁻ = formate, PZDC = 1H-pyrazole-3,5-dicarboxylate, 2,5-PylDC = pyrrole-2,5-dicarboxylate, MTB = 4,4′,4″,4″-methane-tetrayltetrabenzoate, BTDD = bis(1H-1,2,3-triazolo[4,5-b],[4′,5′-i])dibenzo[1,4]dioxin, BDC = 1,4-benzenedicarboxylate.
^{(b)}The volume of the modulators, which is much lower than that of other solvents in the reaction, was not listed.
EtOH = ethanol, MeOH = methanol, DMF = N, N-Dimethylformamide, and HCOOH = formic acid.
^{(c)}The exact weight of dry MOF obtained per batch was not given, and the number was calculated based on the reaction yield.
^{(d)}Yield of each MOF based on the amounts of corresponding linkers.

1. A composition comprising a multivariate metal-organic framework (MTV-MOF) for high yield water harvesting, formulated as PT-MOFs: [Al(OH)(PZDC)₁₋ₓ(TDC)ₓ], covering the entire linker mixing range, wherein x is a 0 to 1 (e.g. x=0, 0.125, 0.25, 0.375, 0.5, 0.625, 0.75, 0.875, 1; FIG. 1a-c) wherein TDC is linker thiophene-2,5-dicarboxylate and PZDC is 1H-pyrazole-3,5-dicarboxylate.

2. The composition of claim 1, wherein the PT-MOF is selected from: PT80, PT71, PT62, PT53, PT44, PT35, PT26, PT17, PT08, identified by PTnm, wherein P is H₂PZDC, T is H₂TDC, n is mole ratio of H₂PZDC, and m is mole ratio of H₂TDC.

3. The composition of claim 1, disposed in a scale-up reaction vessel of FIG. 3.

4. A method of making a composition of claim 1, comprising synthesizing the MTV-MOF in a hydrothermal reaction between a metal and deprotonated linkers mixed at different ratios in a relatively rapid, facile, scalable (e.g. multi-kg), and high-yield (e.g. (≥90%) synthesis method of the MTV-MOF on a kilogram-scale.

5. A method of making a multivariate metal-organic framework (MTV-MOF) composition comprising synthesizing the MTV-MOF in a hydrothermal reaction between a metal and deprotonated linkers mixed at different ratios in a relatively rapid, facile, scalable (e.g. multi-kg), and high-yield (e.g. (≥90%) synthesis method of the MTV-MOF on a kilogram-scale.

6. The method of claim 5, wherein the MTV-MOF is composed of metal cluster-based secondary building units (SBUs) and carboxylate linkers that are connected by ionic or covalent bonds, wherein the SBUs contain one or more species of metal ions, including Li⁺, Na⁺, K⁺, Rb⁺, Cs⁺, Be²⁺, Mg²⁺, Ca²⁺, Sr²⁺, Ba²⁺, Sc²⁺, Y³⁺, Ti⁴⁺, Zr⁴⁺, Hf⁴⁺, V⁵⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, B³⁺, B⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb³⁺, Sb³⁺, Sb⁺, Bi⁵⁺, Bi³⁺, Bi⁺ and their combinations, wherein in order to be charge-balanced, the SBUs can contain anion, such as O²⁻, N³⁻ and S²⁻, and optionally, the bridging —OH and neutral solvent molecules such as dimethylformamide and water can also be a part of the SBU, and the carboxylate linkers are organic aromatic or nonaromatic rings or chains that contains two or more carboxylate groups.

7. The method of claim 6, wherein the MTV-MOF comprises linkers of Table A.

8. The method of claim 5, producing the MTV-MOF at kilogram scale in a 200 L batch reactor with yields of 84-96% and space-time yields of 238-305 kg/day/m³.

9. The method of claim 5, wherein the reaction is facilitated by a mechanical, continuous stirring mechanism to constantly stir the reaction mixture to ensure the solution of the linkers is homogeneously dispersed, which is important to ensure a precise control on the linker composition of the resulting MTV-MOF, and not achievable by traditional methods, which can result in a formation of physical mixture of two MOFs instead of MTV-MOFs.

10. The method of claim 5, comprising use of a conductive temperature regulator surrounding the reaction vessel, such as a heating jacket or oil bath.

11. The method of claim 5, comprising use of slow addition, to yield the MTV-MOF products with a homogeneous particle size and sorption performance.

12. The method of claim 5, comprising use of corrected stoichiometry amount of base, e.g., 3 equivalence of base (e.g. mol of NaOH to mol of linker is 3 to maximize the reaction yield, as shown in table, the yield increase from ˜30% to >80%).

13. The method claim 5, configured to tune the water-harvesting properties of the synthesized MTV-MOF by varying the input linker ratio and thus producing MTV-MOFs with desired linker composition and properties.

14. The method of claim 5, wherein the MTV-MOF comprises pyrazoledicarboxylate and other heterocyclic dicarboxylate linkers (2,5-furandicarboxylate, 2,5-thiophenedicarboxylate, 3,4-pyrroledicarboxylate, etc.).

15. The method of claim 5, configured to produce compositions sufficient for water harvesting from desert air, adsorption-driven heat exchangers, adsorption-driven chillers, heat pumps, for air-conditioning, and/or in indoor humidity and moisture controllers.

16. The method of claim 5, wherein the MTV-MOF is selected from: MOF-303, CAU-23, MIL-160, MOF-313, CAU-10, and Al-fumarate, or MOF-5, MOF-177, IRMOF-1, IRMOF-8, MIL-53, MOF-801, UiO-66, HKUST-1, and NOTT-400.
